(19) United States
(12) Patent Application Publication
(10) Pub. No.: US 2026/0091582 A1
(43) Pub. Date: Apr. 2, 2026

(54) LIQUID EJECTION HEAD AND APPARATUS

(71) Applicant: RISO Technologies Corporation, Tokyo (JP)

(72) Inventor: Yasuhito KIJI, Mishima Shizuoka (JP)

(21) Appl. No.: 19/334,725

(22) Filed: Sep. 19, 2025

(30) Foreign Application Priority Data
Sep. 27, 2024 (JP) 2024-168074
Jul. 14, 2025 (JP) 2025-118626

(51) Int. Cl. B41J 2/045

(52) U.S. Cl. CPC B41J 2/04588; B41J 2/04508; B41J 2/0455; B41J 2/0457; B41J 2/04573; B41J 2/04581

(57) ABSTRACT

A liquid ejection head includes a nozzle, a pressure chamber capable of storing liquid and communicating with the nozzle, a volume of the chamber being varied to eject the liquid from the nozzle, an actuator configured to vary the volume of the chamber in response to a drive signal, and a drive circuit configured to generate the signal. The signal includes a plurality of ejection waveforms having waveform widths that are substantially the same and are different from a half cycle of a main acoustic resonance frequency of the liquid in the chamber. An interval between centers of two of the ejection waveforms that are adjacent to each other coincides with a period between generation of a residual vibration of the liquid in the pressure chamber by one of the two ejection waveforms and strengthening of the residual vibration by the other of the two ejection waveforms.

### CROSS-REFERENCE TO RELATED APPLICATION

This application is based upon and claims the benefit of priority from Japanese Patent Application No. 2024-168074, filed on Sep. 27, 2024, and No. 2025-118626, filed on Jul. 14, 2025, the entire contents of which are incorporated herein by reference.

### FIELD

Embodiments described herein relate generally to a liquid ejection head and apparatus.

### BACKGROUND

In the related art, techniques for ejecting droplets such as ink using a liquid ejection head have been disclosed. In such a liquid ejection head, the dot diameter formed when a droplet lands on a medium can be enlarged by successively ejecting multiple droplets, thereby achieving gradation in ink density on the medium.

However, when the main acoustic resonance frequencies of the individual pressure chambers differ, applying the same drive waveform, the pulse widths of which are unequal for the first and last drops, to all chambers while successively ejecting droplets can prevent the droplets from merging as intended, leading to degraded printing quality.

### BRIEF DESCRIPTION OF THE DRAWINGS

FIG. 1 is a cross-sectional view showing a configuration of a liquid ejection head according to an embodiment.

FIG. 2 is a cross-sectional view showing the configuration of the liquid ejection head.

FIG. 3 is a block diagram schematically showing a configuration of a drive circuit.

FIG. 4 is a diagram showing a configuration of a liquid ejection device.

FIG. 5 is a block diagram showing an example of a configuration of the liquid ejection device.

FIG. 6 is a diagram showing an example of a drive waveform including an ejection waveform by which two droplets are continuously ejected and a cancel waveform.

FIG. 7 is a diagram showing an example of a drive waveform and an acoustic vibration.

FIG. 8 is a diagram showing an example of a drive waveform including an ejection waveform by which three droplets are continuously ejected and a cancel waveform.

FIG. 9 is a diagram showing an example of a drive waveform including an ejection waveform by which a single droplet is continuously ejected and a cancel waveform of a liquid ejection head according to a comparative example.

FIG. 10 is a diagram showing an example of the drive waveform.

FIG. 11 is a diagram showing a relation between a waveform width and an ejection force based on conditions of a time width of a leading droplet and a subsequent droplet.

FIG. 12 is a diagram showing the relation between the waveform width and the ejection force.

FIG. 13 is a diagram showing the relation between the waveform width and the ejection force.

FIG. 14 is a diagram showing the relation between the waveform width and the ejection force.

FIG. 15 is a diagram showing the relation between the waveform width and the ejection force.

FIG. 16 is a diagram showing the relation between the waveform width and the ejection force.

FIG. 17 is a diagram showing the relation between the waveform width and the ejection force.

FIG. 18 is a diagram showing the relation between the waveform width and the ejection force.

FIG. 19 is a diagram showing the relation between the waveform width and the ejection force.

FIG. 20 is a diagram showing the relation between the waveform width and the ejection force.

FIG. 21 is a diagram showing the relation between the waveform width and the ejection force.

FIG. 22 is a diagram showing the relation between the waveform width and the ejection force.

FIG. 23 is a diagram showing the relation between the waveform width and the ejection force.

FIG. 24 is a diagram showing the relation between the waveform width and the ejection force.

FIG. 25 is a block diagram schematically showing a configuration of a drive circuit of a liquid ejection head according to another embodiment.

FIG. 26 is a diagram showing an example of a drive waveform including an ejection waveform by which two droplets are continuously ejected and a cancel waveform.

FIG. 27 is a diagram showing an example of a drive waveform and an acoustic vibration.

FIG. 28 is a diagram showing an example of a drive waveform including an ejection waveform by which two droplets are continuously ejected and a cancel waveform.

FIG. 29 is a diagram showing an example of the drive waveform.

### DETAILED DESCRIPTION

A liquid ejection head and apparatus are provided that can make an ejection force of each droplet substantially uniform and can increase an ejection speed of subsequent droplets.

In general, according to one embodiment, a liquid ejection head comprises: a nozzle plate including a nozzle; a pressure chamber that is capable of storing liquid and communicates with the nozzle, a volume of the pressure chamber being varied to eject the liquid from the nozzle; an actuator configured to vary the volume of the pressure chamber in response to a drive signal; and a drive circuit configured to generate the drive signal. The drive signal includes a plurality of ejection waveforms having waveform widths that are substantially the same and are different from a half cycle of a main acoustic resonance frequency of the liquid in the pressure chamber, and an interval between centers of two of the ejection waveforms that are adjacent to each other coincides with a period between generation of a residual vibration of the liquid in the pressure chamber by one of the two ejection waveforms and strengthening of the residual vibration by the other of the two ejection waveforms.

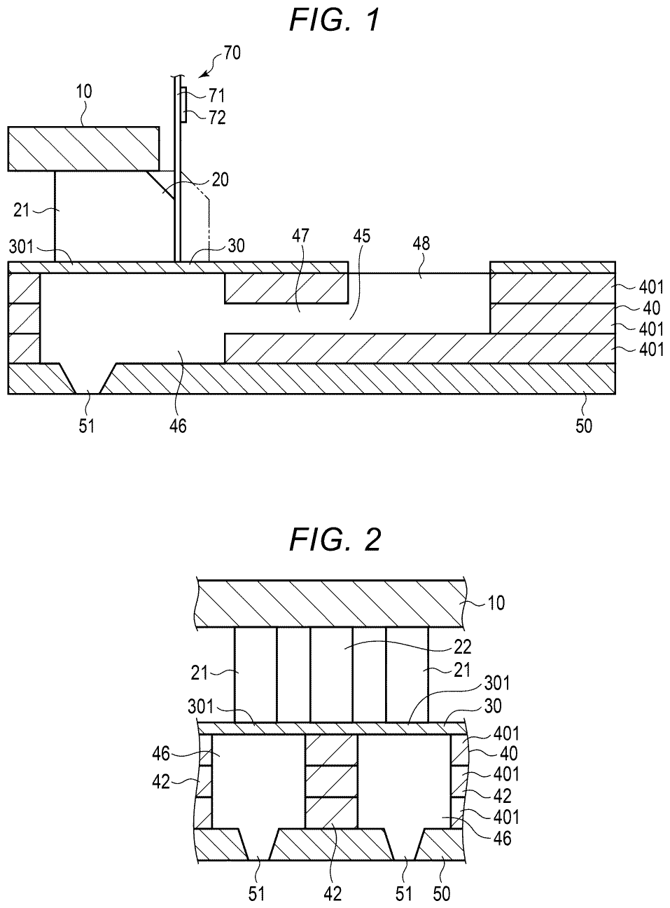

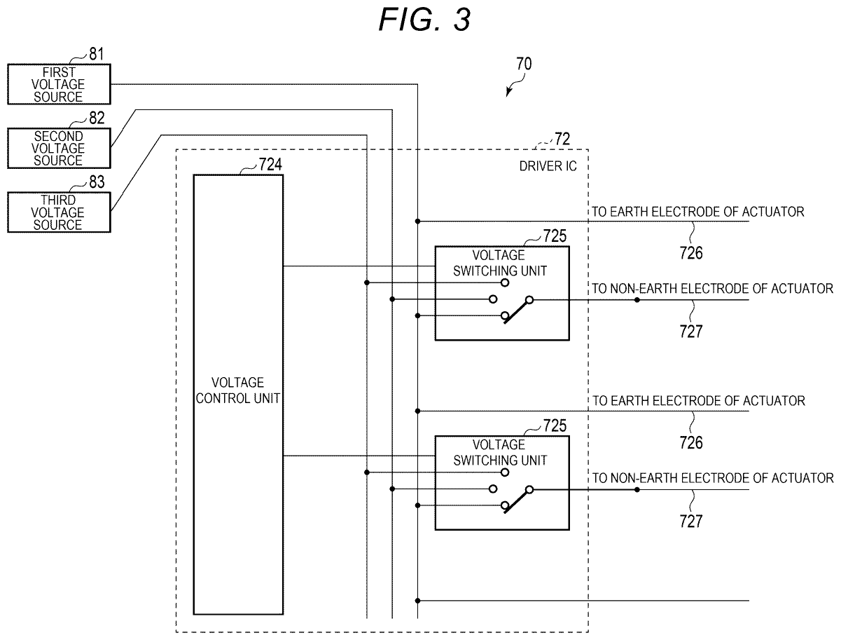

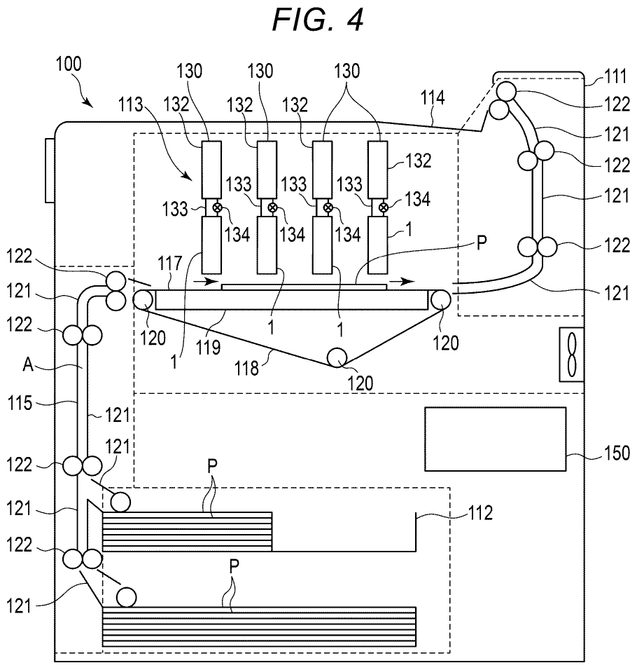

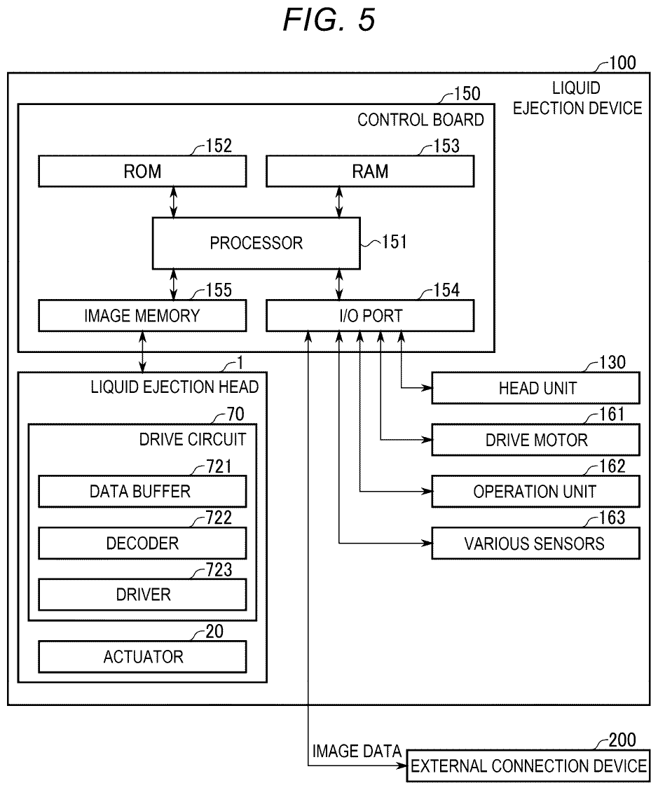

Configurations of a liquid ejection head 1 and a liquid ejection device 100 using the liquid ejection head 1 according to an embodiment will be described below with reference to FIGS. 1 to 5. FIG. 1 is a cross-sectional view showing a configuration of the liquid ejection head 1 according to an embodiment, and FIG. 2 is a cross-sectional view showing the configuration of the liquid ejection head 1. FIG. 3 is a block diagram schematically showing a configuration of a drive circuit 70 of the liquid ejection head 1. FIG. 4 is a diagram showing the configuration of a liquid ejection device 100 using the liquid ejection head 1, and FIG. 5 is a block diagram showing an example of the configuration of a liquid ejection device 100. In the drawings, a structure is shown enlarged, reduced, or omitted as appropriate for the purpose of description.

The liquid ejection head 1 according to an embodiment is, for example, an inkjet head that ejects ink. As shown in FIGS. 1 and 2, the liquid ejection head 1 includes a base 10, an actuator 20, a vibration plate 30, a flow path plate 40, a nozzle plate 50 having a plurality of nozzles 51, and the drive circuit 70.

The base 10 is formed in, for example, a rectangular plate shape. The actuator 20 is bonded to the base 10.

The actuator 20 is, for example, a piezoelectric member including a plurality of piezoelectric pillars 21 and non-drive piezoelectric pillars 22 arranged alternately with the plurality of piezoelectric pillars 21. The actuator 20 is formed in a comb shape by arranging the plurality of piezoelectric pillars 21 and the plurality of non-drive piezoelectric pillars 22 in one direction at predetermined intervals. For example, in such an actuator 20, grooves are formed by dicing a laminated piezoelectric member bonded to the base 10 from an end surface opposite to a base 10 side, and a plurality of piezoelectric elements formed in a rectangular columnar shape are formed at predetermined intervals with respect to one piezoelectric member. Then, the plurality of formed piezoelectric elements are provided with electrodes or the like to constitute the plurality of piezoelectric pillars 21 and the plurality of non-drive piezoelectric pillars 22 which are alternately arranged as the piezoelectric elements. That is, one end side (i.e., a vibration plate 30 side) of the actuator 20 is divided into a plurality of parts by the plurality of formed grooves, and the other end side (i.e., the base 10 side) is connected.

For example, the laminated piezoelectric members constituting the actuator 20 are formed by laminating and sintering sheet-shaped piezoelectric materials. For example, as shown in FIGS. 1 and 2, the piezoelectric pillars 21 and the non-drive piezoelectric pillars 22 are, for example, laminated piezoelectric bodies as the drive elements. The piezoelectric pillar 21 and the non-drive piezoelectric pillar 22 include a plurality of laminated piezoelectric layers, a plurality of internal electrodes formed on surfaces of the piezoelectric layers, and a plurality of external electrodes. For example, the piezoelectric pillars 21 and the non-drive piezoelectric pillars 22 have the same configuration.

The piezoelectric layer is formed of a piezoelectric material such as a lead zirconate titanate (PZT) based material or a lead-free sodium potassium niobate (KNN) based material into a thin plate shape. The plurality of piezoelectric layers are stacked in a thickness direction and bonded by sintering. The lamination direction of the piezoelectric layers is orthogonal to an arrangement direction of the piezoelectric pillars 21 and the non-drive piezoelectric pillars 22.

The internal electrode is a conductive film formed in a predetermined shape and formed of a sinterable conductive material such as silver palladium. The internal electrode is formed in predetermined regions on the surfaces of the piezoelectric layers. The plurality of internal electrodes are alternately formed to have different poles in the arrangement direction.

The external electrodes are formed on surfaces of the plurality of piezoelectric pillars 21 and the plurality of non-drive piezoelectric pillars 22, and are formed by collecting end portions of the internal electrodes. The external electrode is formed of Ni, Cr, Au, or the like by a known method such as plating or sputtering. The plurality of external electrodes are disposed on different side surface portions of the plurality of piezoelectric pillars 21 and the plurality of non-drive piezoelectric pillars 22, respectively, and have different poles. The different external electrodes may be disposed in different regions on the same side surface portions of the plurality of piezoelectric pillars 21 and the plurality of non-drive piezoelectric pillars 22.

In one embodiment, the plurality of external electrodes include individual electrodes respectively formed on the plurality of piezoelectric pillars 21 and the plurality of non-drive piezoelectric pillars 22, and common electrodes continuously formed on the plurality of piezoelectric pillars 21 and the plurality of non-drive piezoelectric pillars 22. The plurality of individual electrodes formed on the plurality of piezoelectric pillars 21 and the plurality of non-drive piezoelectric pillars 22 are disposed independently of each other. The common electrode is grounded, for example.

These external electrodes are connected to, for example, the drive circuit 70. For example, each of the external electrodes is connected to a control unit 150 serving as a drive unit via a driver 723 (to be described later) of the drive circuit 70 through a wiring, and is implemented to be driven under control of a processor 151.

When a voltage is applied to the internal electrode via the external electrode, the piezoelectric pillars 21 and the non-drive piezoelectric pillars 22 vibrate longitudinally along the lamination direction of the piezoelectric layers. The term “vibrate longitudinally” referred to here is, for example, “vibrate in a thickness direction defined by a piezoelectric constant d33”. For example, as shown in FIG. 2, the plurality of alternating piezoelectric pillars 21 are disposed corresponding to pressure chambers 46 with the vibration plate 30 interposed therebetween, and the remaining non-drive piezoelectric pillars 22 are disposed at positions facing partition wall portions 42 with the vibration plate 30 interposed therebetween.

When a voltage is applied, the piezoelectric pillar 21 vibrates longitudinally to displace the vibration plate 30. That is, the piezoelectric pillars 21 deform the pressure chambers 46. The non-drive piezoelectric pillar 22 is disposed to face the partition wall portion 42. No voltage is applied to the non-drive piezoelectric pillar 22. That is, each piezoelectric pillar 21 constitutes an actuator that deforms the pressure chamber 46, and each non-drive piezoelectric pillar 22 constitutes a support pillar. That is, the piezoelectric pillar 21 changes a volume of a pressure chamber 46 by expanding and contracting the pressure chamber 46.

The vibration plate 30 is bonded to one side in the lamination direction of the piezoelectric layers of the plurality of piezoelectric pillars 21 and 22, that is, its surface on the nozzle plate 50 side. The vibration plate 30 is deformed by, for example, driving the piezoelectric pillars 21. The vibration plate 30 is bonded to the piezoelectric pillars 21 and the non-drive piezoelectric pillars 22 of the actuator 20.

The vibration plate 30 has, for example, the shape of a flat plate disposed such that the thickness direction corresponds to the lamination direction of the piezoelectric layer. The plane direction of the vibration plate 30 extends in the arrangement direction of the plurality of piezoelectric pillars 21 and the plurality of non-drive piezoelectric pillars 22. The vibration plate 30 is, for example, a metal plate. The vibration plate 30 has a plurality of vibration portions 301 that face the respective pressure chambers 46 and can be displaced individually. The vibration plate 30 is formed by integrally coupling the plurality of vibration portions 301.

For example, the vibration plate 30 is formed in a single flat plate shape, and regions bonded to the piezoelectric pillars 21 are individually displaced. The vibration plate 30 is formed of, for example, a SUS plate. In the vibration plate 30, a fold or a step may be formed at a portion adjacent to the vibration portion 301 or between the vibration portions 301 adjacent to each other so that the plurality of vibration portions 301 are easily displaced.

The vibration plate 30 has a portion that is opposite the piezoelectric pillar 21 and that is displaced by expansion and contraction of the piezoelectric pillar 21 due to longitudinal vibration of the piezoelectric pillar 21, and thereby expands and contracts the pressure chamber 46 and change the volume of the pressure chamber 46.

The vibration plate 30 has a surface on one side bonded to the actuator 20 and a surface on the other side bonded to the flow path plate 40. The pressure chamber 46 capable of containing an ink is formed between the vibration plate 30 and the flow path plate 40.

One surface of the vibration plate 30 faces the piezoelectric pillars 21 and 22, and the other surface faces the pressure chambers 46 and the partition wall portions 42.

The flow path plate 40 is bonded to the vibration plate 30. The flow path plate 40 is disposed between the nozzle plate 50 and the vibration plate 30. The flow path plate 40 has the plurality of partition wall portions 42. The flow path plate 40 forms a predetermined flow path 45. For example, the flow path plate 40 is formed by laminating a plurality of plates 401 each having an opening to form a plurality of partition wall portions 42 and the predetermined flow path 45.

The plurality of partition wall portions 42 are disposed in the arrangement direction of the plurality of piezoelectric pillars 21 and 22 and face the non-drive piezoelectric pillars 22 via the vibration plate 30. The partition wall portions 42 separate the plurality of pressure chambers 46 (to be described later) of the predetermined flow path 45 and a plurality of individual flow paths 47.

The predetermined flow path 45 includes the plurality of pressure chambers 46 separated by the partition wall portions 42 of the flow path plate 40, the plurality of individual flow paths 47 separated by the partition wall portions 42, and a common flow path 48 communicating with the plurality of individual flow paths 47.

The pressure chambers 46 are arranged in the arrangement direction of the piezoelectric pillars 21 and the non-drive piezoelectric pillars 22, and face the piezoelectric pillars 21 via the vibration plate 30. The plurality of pressure chambers 46 arranged in the one direction are separated by the partition wall portions 42. The plurality of partition wall portions 42 disposed between the plurality of pressure chambers 46 face the plurality of non-drive piezoelectric pillars 22 via the vibration plate 30. The plurality of pressure chambers 46 are formed by closing one side of the flow path plate 40 with the vibration plate 30 and closing the other side with the nozzle plate 50 in the lamination direction of the piezoelectric layers. The nozzle 51 formed in the nozzle plate 50 is disposed in the pressure chamber 46.

The plurality of pressure chambers 46 communicate with the common flow path 48 via the individual flow paths 47. The pressure chamber 46 stores the liquid supplied from the common flow path 48 via the individual flow path 47, and ejects the liquid from the nozzle 51 by being deformed by the vibration of the vibration plate 30 forming a part of the pressure chamber 46. The individual flow path 47 connects the common flow path 48 and the pressure chamber 46. The individual flow paths 47 are provided in the same number as the pressure chambers 46. A flow path cross-sectional shape of the individual flow path 47 is different from a flow path cross-sectional shape of the pressure chamber 46. The flow path cross-sectional area of the individual flow path 47 is smaller than a flow path cross-sectional area of the pressure chamber 46. The common flow path 48 is fluidly connected to the plurality of individual flow paths 47 and communicates with the pressure chambers 46 through the individual flow paths 47.

The nozzle plate 50 is formed of, for example, a metal such as SUS or Ni or a resin material such as polyimide. The nozzle plate 50 is bonded to the flow path plate 40 and covers the plurality of pressure chambers 46. The nozzle plate 50 has a plurality of nozzles 51 formed at positions facing the plurality of pressure chambers 46 and penetrating in the thickness direction. A nozzle row is formed by the plurality of nozzles 51.

As shown in FIG. 5, the drive circuit 70 includes a data buffer 721, a decoder 722, and the driver 723. The data buffer 721 stores printing data in time series for each of the piezoelectric pillars 21 and 22. The decoder 722 controls the driver 723 based on the printing data stored in the data buffer 721 for each of the piezoelectric pillars 21 and 22. The driver 723 outputs drive signals for operating the piezoelectric pillars 21 and 22 under the control of the decoder 722. The drive signal is a voltage signal applied to each of the piezoelectric pillars 21 and 22.

For example, as shown in FIG. 1, the drive circuit 70 includes a wiring film 71 having one end connected to the external electrode, a driver IC 72 mounted on the wiring film 71, and a printed wiring board mounted on the other end of the wiring film 71. For example, the driver IC 72 includes the data buffer 721, the decoder 722, and the driver 723. The driver IC 72 may include a part of the data buffer 721, the decoder 722, and the driver 723, and the printed wiring board or the like may include the remaining part.

The drive circuit 70 applies a drive voltage to the external electrode by the driver IC 72 to drive the piezoelectric pillars 21, changes the volume of the pressure chambers 46, and causes droplets to be ejected from the nozzles 51.

The wiring film 71 is connected to the plurality of individual electrodes and the common electrodes. For example, the wiring film 71 is an anisotropic conductive film (ACF) fixed to connection portions with the external electrode by thermo-compression bonding or the like. The wiring film 71 is, for example, a chip on film (COF) on which the driver IC 72 is mounted.

The driver IC 72 is connected to the external electrode via the wiring film 71. Instead of the wiring film 71, the driver IC 72 may be connected to the external electrode by other methods such as an anisotropic conductive paste (ACP), a non-conductive film (NCF), and a non-conductive paste (NCP).

The driver IC 72 applies a control signal and a drive signal to the respective piezoelectric pillars 21 and 22 to operate the piezoelectric pillars 21. The driver IC 72 generates, according to an image signal input from the control unit 150 of the liquid ejection device 100, a control signal for controlling a timing of ejecting the ink and selecting the piezoelectric pillar 21 that ejects the ink. The driver IC 72 generates a voltage to be applied to the piezoelectric pillar 21, that is, a drive signal, according to the control signal. When the driver IC 72 applies the drive signal to the piezoelectric pillar 21, the piezoelectric pillar 21 displaces the vibration plate 30, thereby driving the pressure chamber 46 to change the volume to expand and contract. Accordingly, the ink filled in the pressure chamber 46 is caused to perform pressure vibration. Due to the pressure vibration, the ink is ejected from the nozzle 51 provided in the pressure chamber 46. The liquid ejection head 1 may be implemented to implement gradation expression by changing an amount of ink droplets that land on a portion of a medium corresponding to one pixel. The liquid ejection head 1 may be implemented to change the amount of ink droplets by changing the number of times of ink ejection. In this manner, the driver IC 72 is an example of an application unit that applies a drive signal to the piezoelectric pillar 21.

Next, an example of the drive circuit 70 will be described with reference to FIG. 3. The drive circuit 70 includes, for example, a voltage control unit 724 and the same number of voltage switching units 725 as the pressure chambers 46 in the driver IC 72. However, in FIG. 3, two voltage switching units 725 are shown, and other voltage switching units 725 are not shown.

The drive circuit 70 is connected to a first voltage source 81, a second voltage source 82, and a third voltage source 83. The drive circuit 70 applies a voltage supplied from the first voltage source 81 to each wiring electrode 726. The drive circuit 70 selectively applies, to wiring electrodes 727, the voltages supplied from the first voltage source 81, the second voltage source 82, and the third voltage source 83. Here, if the actuator 20 is a laminated PZT, since there is a tendency to deteriorate when a bipolar voltage is applied, the voltages supplied by the first voltage source 81, the second voltage source 82, and the third voltage source 83 are set to a ground voltage and either positive or negative with respect to the ground voltage.

An output voltage of the first voltage source 81 is, for example, a ground voltage, and a voltage value thereof is V0 (V0=0 [V]). A voltage value indicated by the output voltage of the second voltage source 82 is V1. The voltage value V1 is higher than V0. A voltage value indicated by the output voltage of the third voltage source 83 is, for example, V2. For example, the voltage value V2 is higher than V0 and lower than V1.

The wiring electrode 726 is connected to a common electrode as an earth electrode of the actuator 20. Each of the plurality of wiring electrodes 727 is connected to an individual electrode as a non-earth electrode of the actuator 20.

The voltage control unit 724 is connected to each of the plurality of voltage switching units 725. The voltage control unit 724 outputs, to each voltage switching unit 725, a command indicating which voltage source among the first voltage source 81, the second voltage source 82, and the third voltage source 83 is selected. For example, the voltage control unit 724 receives an image signal from the control unit 150 and determines a switching timing of the voltage source in each voltage switching unit 725. Further, the voltage control unit 724 outputs the command to select any one of the first voltage source 81, the second voltage source 82, and the third voltage source 83 to the voltage switching unit 725 at a determined switching timing. The voltage switching unit 725 switches the voltage source connected to the wiring electrode 727 according to the command from the voltage control unit 724.

The voltage switching unit 725 includes, for example, a semiconductor switch. The voltage switching unit 725 connects any one of the first voltage source 81, the second voltage source 82, and the third voltage source 83 to the wiring electrode 727 under the control of the voltage control unit 724. Therefore, the internal electrodes of different poles of the piezoelectric pillar 21 are connected to the wiring electrode 726 and the wiring electrode 727 via the external electrodes (i.e., the common electrode and the individual electrode).

Such a drive circuit 70 switches a connection wiring between the voltage sources 81, 82, and 83 and the actuator 20 using the switching circuit including the voltage control unit 724 and the plurality of voltage switching units 725, and inputs drive waveforms having at least three types of potential differences as drive signals between the electrodes of the actuator 20. Here, the drive waveform is a drive waveform by which droplets are ejected by driving the actuator 20. Here, a potential difference other than the largest potential difference and the smallest potential difference is referred to as an intermediate potential difference.

The printed wiring board is a printing wiring assembly (PWA) on which various electronic components or connectors are mounted. The printed wiring board is connected to the control unit 150 of the liquid ejection device 100.

Next, an example of the liquid ejection device 100 including the liquid ejection head 1 will be described with reference to FIGS. 4 and 5. The liquid ejection device 100 is, for example, an inkjet printing device. The liquid ejection device 100 includes a housing 111, a medium supply unit 112, an image forming unit 113, a medium discharge unit 114, and a conveying device 115. In addition, the liquid ejection device 100 includes the control unit 150.

The liquid ejection device 100 executes image forming processing on sheets P by ejecting liquid such as ink while conveying the sheet P serving as a printing medium that is an ejection target along a predetermined conveying path A from the medium supply unit 112 to a medium discharge unit 114 through the image forming unit 113.

The housing 111 is an outer shell of the liquid ejection device 100. A discharge port through which the sheet P is to be discharged to the outside is provided at a predetermined position of the housing 111.

The medium supply unit 112 includes a plurality of sheet feed cassettes, and can hold a plurality of sheets P of various sizes in a manner of laminating the sheets P.

The medium discharge unit 114 includes a sheet discharge tray that can hold the sheet P discharged from the discharge port.

The image forming unit 113 includes a support portion 117 that supports the sheet P, and a plurality of head units 130 facing the support portion 117 above the support portion 117.

The support portion 117 includes a conveying belt 118 provided in a loop shape in a predetermined region where image formation is performed, a support plate 119 that supports the conveying belt 118 from a back side, and a plurality of belt rollers 120 provided on the back side of the conveying belt 118.

During the image formation, the support portion 117 supports the sheet P on a holding surface that is an upper surface of the conveying belt 118, and conveys the sheet P to a downstream side by sending the conveying belt 118 at a predetermined timing by rotation of the belt rollers 120.

The head unit 130 includes the liquid ejection head 1, a plurality of ink tanks 132 as liquid tanks mounted on the liquid ejection head 1, a connection flow path 133 that connects the liquid ejection head 1 and the ink tanks 132, and a supply pump 134.

In one embodiment, a plurality of head units 130 are provided. The head units 130 use inks of different colors. For example, the plurality of head units 130 include the liquid ejection heads 1 of four colors of cyan, magenta, yellow, and black and the ink tanks 132 that respectively store the inks of the respective colors. The ink tank 132 is connected to the common flow path 48 of the liquid ejection head 1 by the connection flow path 133.

A negative pressure control device such as a pump (not shown) is connected to the ink tank 132. A negative pressure in the ink tank 132 is controlled by the negative pressure control device according to water head values of the liquid ejection head 1 and the ink tank 132, thereby forming the ink supplied to each nozzle 51 of the liquid ejection head 1 into a meniscus having a predetermined shape.

The supply pump 134 is, for example, a liquid sending pump formed of a piezoelectric pump. The supply pump 134 is provided in a supply flow path. The supply pump 134 is connected to the control unit 150 by wiring and is controlled by the control unit 150. The supply pump 134 supplies the liquid to the liquid ejection head 1.

The conveying device 115 conveys the sheet P along the conveying path A that runs from the medium supply unit 112 through the image forming unit 113 to the medium discharge unit 114. The conveying device 115 includes a plurality of guide plate pairs 121 disposed along the conveying path A and a plurality of conveying rollers 122.

Each of the plurality of guide plate pairs 121 includes a pair of plate members facing each other across the sheet P to be conveyed, and guides the sheet P along the conveying path R.

The conveying roller 122 is driven and rotated under the control of the control unit 150, thereby conveying the sheet P to the downstream side along the conveying path A. Sensors that detect a sheet conveying state are disposed at various positions in the conveying path A.

The control unit 150 is, for example, a control board or circuit. The control unit 150 includes a processor 151, a read only memory (ROM) 152, a random access memory (RAM) 153, an input and output (I/O) port 154, and an image memory 155.

The processor 151 is a processing circuit such as a central processing unit (CPU) that serves as a control unit. The processor 151 controls the head unit 130, a drive motor 161, an operation unit 162, various sensors 163, and the like provided in the liquid ejection device 100 through the I/O port 154. The processor 151 transmits printing data stored in the image memory 155 to the drive circuit 70 in a drawing order.

The ROM 152 stores various programs. The RAM 153 temporarily stores various types of variable data, image data, and the like. The ROM 152 and the RAM 153 are examples of memories, and other memories or storage media may be used to store various programs, data, and the like. The I/O port 154 is an interface unit that inputs data from the outside of an externally connected device 200 and outputs data to the outside. The printing data from the externally connected device 200 is transmitted to the control unit 150 through the I/O port 154, and is stored in the image memory 155.

Hereinafter, characteristics of the liquid ejection head 1 used in the liquid ejection device 100 according to the embodiment and a drive waveform (a drive signal for ejecting a droplet) of the liquid ejection head 1 will be described. The ejection waveform of the drive signal of the liquid ejection head 1 according to the embodiment includes an expansion potential difference for expanding the volume of the pressure chamber 46, a contraction potential difference for contracting the volume of the pressure chamber 46, and at least one intermediate potential difference between the expansion potential difference and the contraction potential difference.

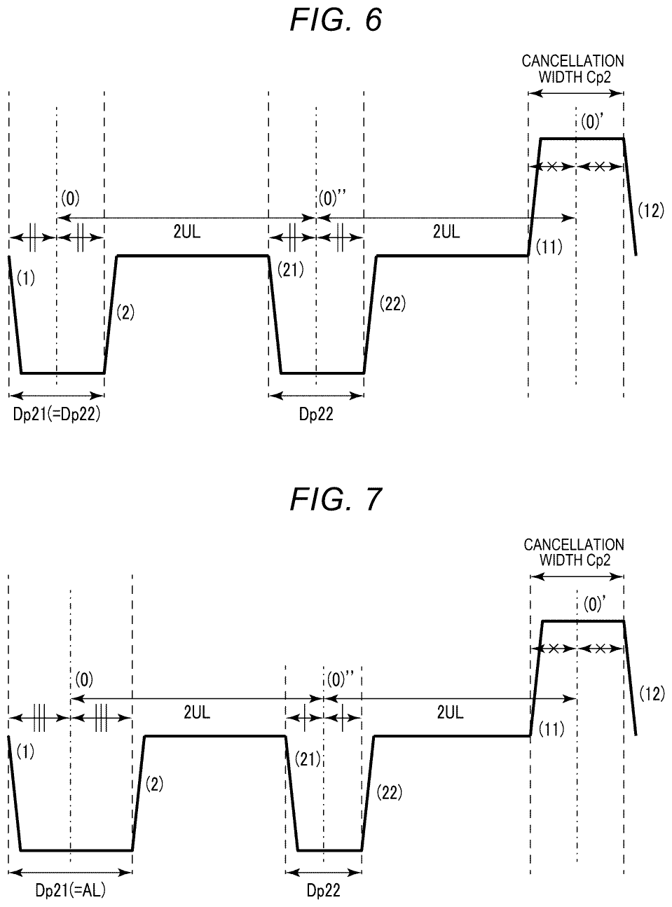

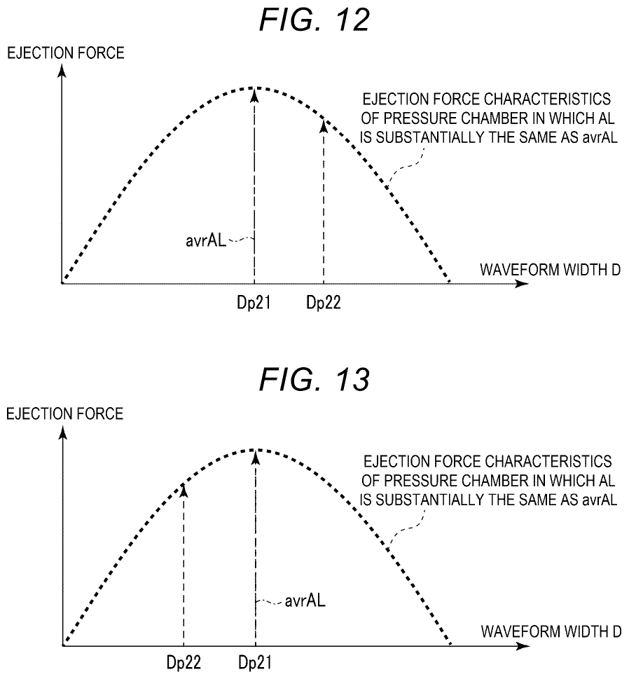

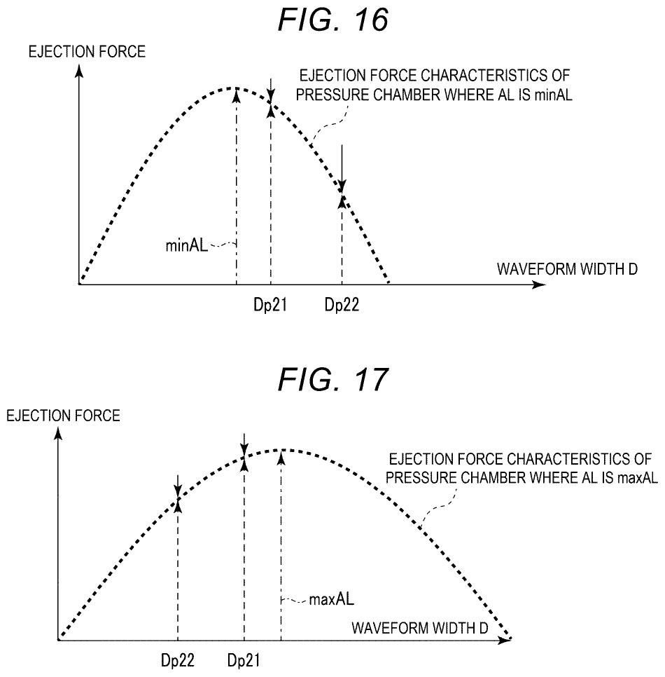

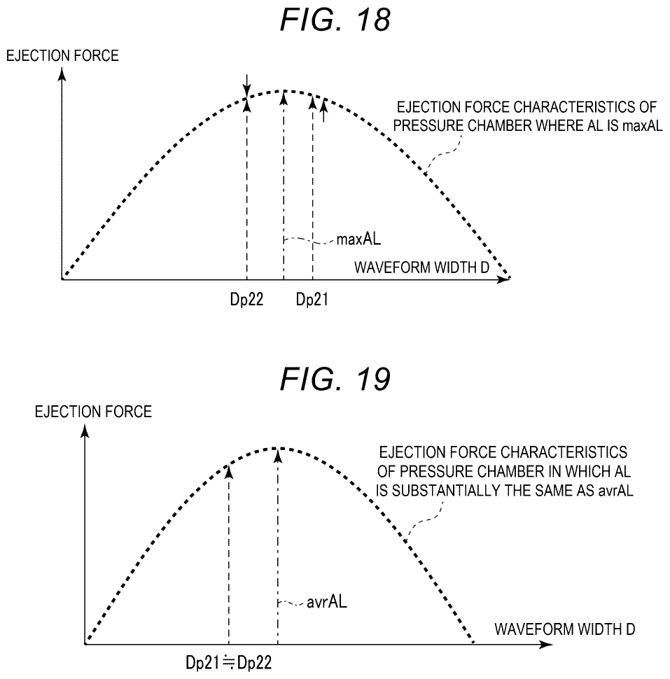

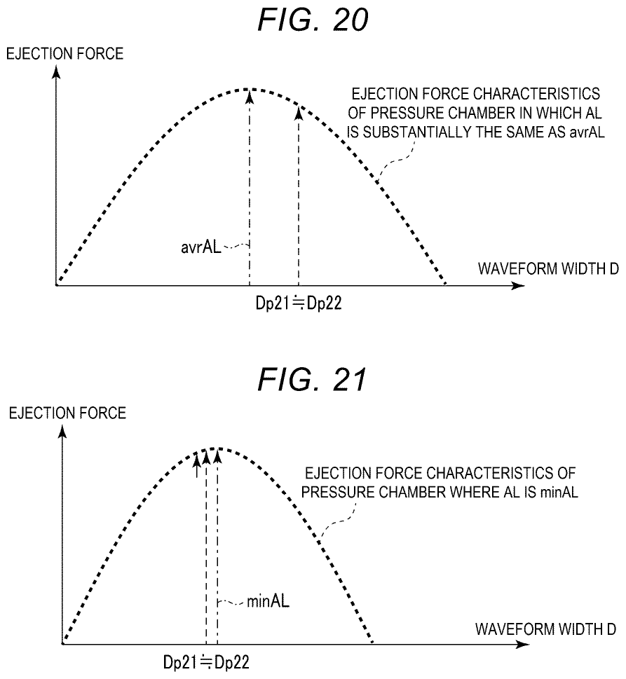

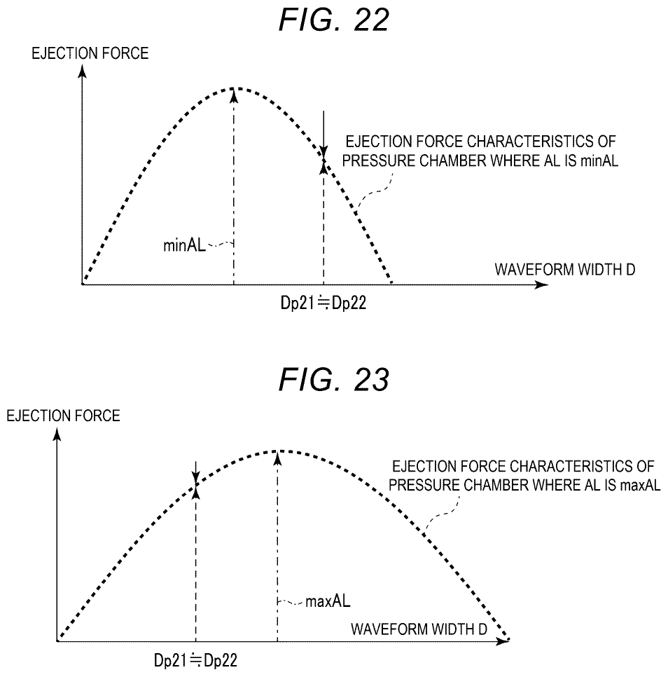

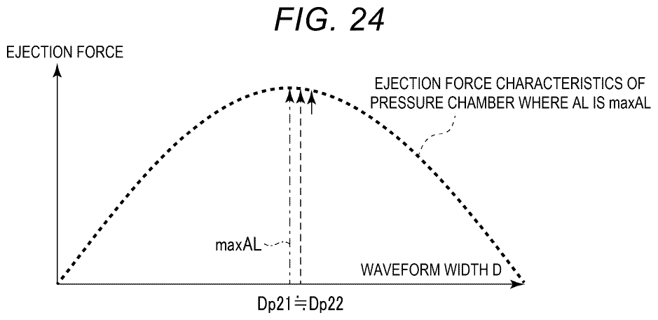

First, the drive waveform of the liquid ejection head 1 will be described with reference to FIGS. 6 to 24. FIG. 6 is a diagram showing an example of a drive waveform including a multi-drop ejection waveform by which two droplets from the liquid ejection head 1 are continuously ejected and a cancel waveform. FIG. 7 is a diagram showing a liquid ejection head in the related art as a comparative example, and is a diagram showing an example of a drive waveform including a multi-drop ejection waveform by which a plurality of droplets from the liquid ejection head according to the comparative example are continuously ejected and a cancel waveform.

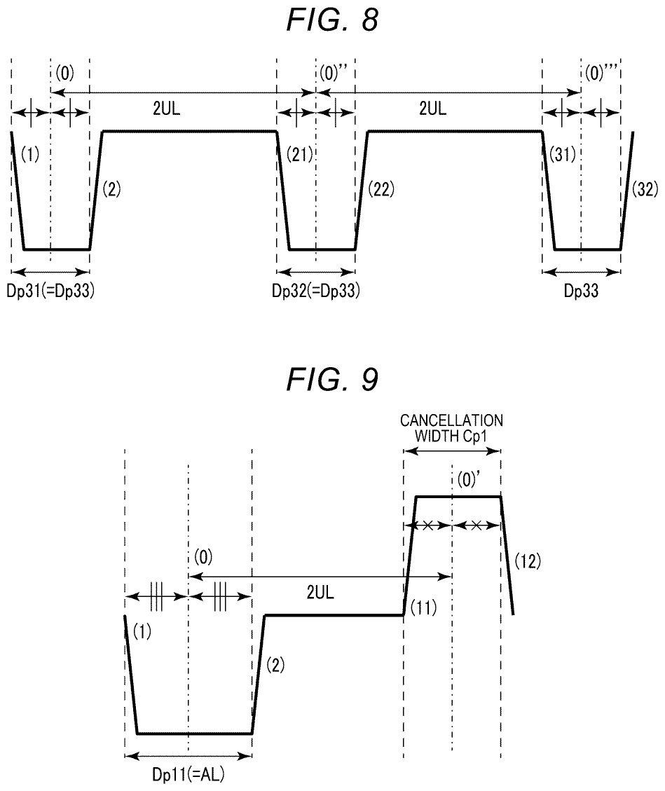

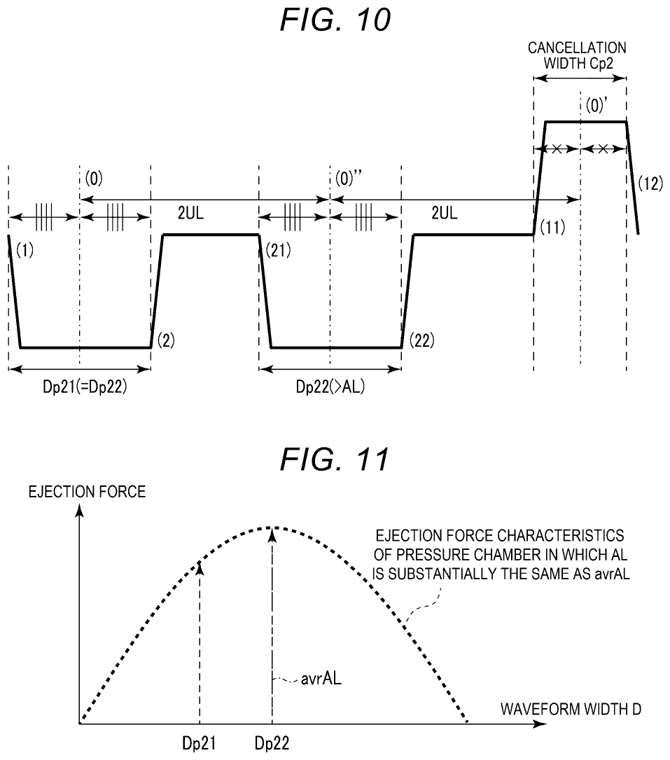

FIG. 8 shows an example of a drive waveform including a multi-drop ejection waveform by which three liquid droplets of the liquid ejection head 1 according to another embodiment are ejected, and a cancel waveform is omitted. FIG. 9 is a diagram showing, as an example in the related art, a drive waveform including an ejection waveform by which a single droplet from the liquid ejection head 1 is ejected and a cancel waveform, and FIG. 10 is a diagram showing, as another embodiment, a drive waveform including a multi-drop ejection waveform and a cancel waveform by which two droplets from the liquid ejection head 1 are continuously ejected, in which a time width Dp of the ejection waveform is larger than a half cycle AL of a main acoustic vibration frequency of the pressure chamber 46.

FIGS. 11 to 24 are diagrams showing a relation between a waveform width and an ejection force based on the conditions of the time width Dp of a leading droplet and a subsequent droplet in the ejection waveform by which two droplets are ejected. FIGS. 11 to 18 show an example in which the time width Dp21 of the ejection waveform of the leading droplet and the time width Dp22 of the ejection waveform of the subsequent droplet are different (Dp21≠Dp22), and FIGS. 19 to 24 show an example in which Dp21 of the leading droplet and Dp22 of the subsequent droplet are the same or substantially the same (Dp21≈Dp22).

First, the liquid ejection head 1 performs, for example, gradation expression by the number of continuously ejected droplets of ink. Here, if there are a plurality of nozzles 51 that eject the same number of droplets, the same drive waveform is input to the plurality of piezoelectric pillars 21 that change the volumes of the plurality of pressure chambers 46 communicating with the plurality of nozzles 51. Meanwhile, the main acoustic vibration frequencies of the plurality of pressure chambers 46 are not necessarily the same due to manufacturing variations or the like. For example, a drive waveform for driving the liquid ejection head 1 in which a maximum value of the half cycle AL of the main acoustic vibration frequencies of the plurality of pressure chambers 46 is 3.5 μs, a minimum value is 2.5 μs, and an average value is 3.0 μs will be described below.

AL of the plurality of pressure chambers 46 can be checked by individually inputting a rectangular wave to the piezoelectric pillar 21 that changes the volume of each pressure chamber 46 and measuring the speed of the droplets ejected from the nozzle at that time. For example, when the speed of the droplet ejected is measured while changing the time width of the rectangular wave and the ejection speed of the droplet is maximized when the time width of the rectangular wave is 3.0 μs, 3.0 μs can be considered as AL of the corresponding pressure chamber 46.

Next, the characteristics of the drive waveform in the related art will be described. For example, when printing on a medium by ejecting droplets from the liquid ejection head 1 while conveying a medium to be printed, it is necessary to adjust the speed of the droplets of each volume so that a landing position of the droplets on the medium does not change even if the volume of the droplets ejected from the nozzles 51 changes.

First, as shown in FIG. 9, a drive waveform by which a droplet of one drop is ejected is a rectangular wave having a time width Dp11 of 1 AL. Further, as for the waveform width of the ejection waveform by which each droplet of the drive waveform by which a plurality of droplets are continuously ejected is ejected, the waveform width of the ejection waveform of a leading droplet or a last droplet is set to 1 AL, and the waveform width of the ejection waveform of other droplets is set to be either smaller or larger than 1 AL, thereby adjusting a speed of the droplets when the droplets are continuously ejected, and setting the speed to be close to the ejection speed of one drop. In this way, when droplets are continuously ejected, since a residual vibration of the pressure chamber 46 is generated by ejecting droplets first, the ejection speed of the subsequent droplet increases by ejecting the next droplet according to the phase of the residual vibration. In the case of one drop, since an increase in speed due to the residual vibration cannot be expected, the waveform width of the ejection waveform of one drop is set to 1 AL, and the ejection waveform width is adjusted when continuously ejecting droplets.

For example, a case is considered in which the drive waveform by which two drops are continuously ejected as shown in FIG. 7 is adjusted in the pressure chamber 46 in which AL is approximately 3.0 μs among the plurality of pressure chambers 46, and the 2-drop waveform is set to Dp21=3.0 μs, UL=3.0 μs, Dp22=2.1 μs, and Cp=1.5 μs, the speed of the ejection droplet of the second drop of the 2-drop waveform is faster than the speed of the ejection droplet of the first drop of the 2-drop waveform.

In the 2-drop waveform, in order to match the phases of the residual vibration generated by the ejection waveform of Dp21 and the ejection waveform of Dp22, a center-to-center distance 2 UL between the ejection waveform of Dp21 and the ejection waveform of Dp22 (a time interval between centers) is set to be twice AL of the pressure chamber 46, and even if the waveform width of Dp22 is a value smaller than AL of the pressure chamber 46, the speed of the ejection droplet of the second drop of the 2-drop waveform is faster than the speed of the ejection droplet of the first drop of the 2-drop waveform.

Here, when the 2-drop waveform shown in FIG. 7 is input to the piezoelectric pillar 21 that changes the volume of the pressure chamber 46 in which AL is the maximum value of 3.5 μs among the plurality of pressure chambers 46, a difference between the waveform width of Dp22 and AL of the pressure chamber 46 increases, and in addition, a difference between the center-to-center distance 2 UL between the ejection waveform of Dp21 and the ejection waveform of Dp22 and 2 AL of the pressure chamber 46 also increases, and therefore, there is a concern that the speed of the ejection droplet of the second drop is slower than the speed of the ejection droplet of the first drop of the 2-drop waveform. Accordingly, when the timing at which the ejection droplet of the second drop lands on the medium is later than the timing at which the ejection droplet of the first drop lands on the medium, the printing quality is deteriorated.

In FIGS. 11 to 24, the horizontal axis represents the waveform width of the ejection waveform, the vertical axis represents the ejection force with respect to the waveform width when there is no residual vibration, and ejection force characteristics of the pressure chamber 46 are schematically shown by broken lines. Here, avrAL is an average value of AL of the plurality of pressure chambers 46 to which the same drive waveform is input. minAL is a minimum value of AL of the plurality of pressure chambers 46 to which the same drive waveform is input. maxAL is a maximum value of AL of the plurality of pressure chambers 46 to which the same drive waveform is input. In FIGS. 11 to 14 and FIGS. 19 and 20, an upwardly convex broken line indicates the ejection force characteristics in the pressure chamber 46 in which AL is substantially the same as avrAL.

FIG. 13 shows the relation between the waveform width and the ejection force when Dp21 has the same time width as avrAL and Dp22 has a time width smaller than avrAL in the waveform of FIG. 7. In FIG. 13, the ejection force of Dp22 is slightly smaller than that of Dp21, but in the waveform of FIG. 7, the residual vibration generated by Dp21 strengthens with Dp22, so that the droplet speed ejected by Dp22 becomes equal to or faster than the droplet speed ejected by Dp21.

FIG. 17 is a diagram showing a relation between the waveform width and the ejection force when the pressure chamber 46 in which AL is maxAL is driven in the drive waveform as shown in FIG. 7 having the waveform widths of Dp21 and Dp22 shown in the lower left of FIG. 13. Since the waveform width of Dp21 in FIG. 17 is avrAL, the ejection force is near the peak of the ejection force characteristics of the pressure chamber 46, and the change in the ejection force is relatively small. On the other hand, since the waveform width of Dp22 in FIG. 17 is considerably smaller than that of avrAL, the change in the ejection force due to the extension of AL of the pressure chamber 46 is large.

In addition, since the difference between the center-to-center distance 2 UL of the ejection waveform of Dp21 and the ejection waveform of Dp22 and 2 AL (=2*maxAL) of the pressure chamber 46 is large, in FIG. 17, the ejection force is reduced in both Dp21 and Dp22 as compared with FIG. 13, but the reduction in Dp22 is larger. Even if Dp22 and the residual vibration strengthen each other, there is a possibility that the droplet speed ejected by Dp22 becomes slower than the droplet speed ejected by Dp21.

Next, a case is considered in which the drive waveform by which two drops are continuously ejected is adjusted in the pressure chamber 46 in which AL is approximately 3.0 μs among the plurality of pressure chambers 46, and the 2-drop waveform is set to Dp21=2.1 μs, UL=3.0 μs, Dp22=3.0 μs, and Cp=1.5 μs, the speed of the ejection droplet of the second drop of the 2-drop waveform is faster than the speed of the ejection droplet of the first drop of the 2-drop waveform.

In order to match the phases of the residual vibration generated by the ejection waveform of Dp21 and the ejection waveform of Dp22 also in the 2-drop waveform, the center-to-center distance 2 UL between the ejection waveform of Dp21 and the ejection waveform of Dp22 is set to twice AL of the pressure chamber 46, and the speed of the ejection droplet of the second drop of the 2-drop waveform is faster than the speed of the ejection droplet of the first drop of the 2-drop waveform.

Here, the 2-drop waveform is input to the piezoelectric pillar 21 that changes the volume of the pressure chamber 46 in which AL is the minimum value of 2.5 μs among the plurality of pressure chambers 46. The ejection speed of the first drop increases as the difference between the waveform width of Dp21 and AL of the pressure chamber 46 decreases, while the difference between the center-to-center distance 2 UL of the ejection waveforms of Dp21 and Dp22 and 2 AL of the pressure chamber 46 increases. Therefore, there is a concern that the speed of the ejection droplet of the second drop is slower than the speed of the ejection droplet of the first drop of the 2-drop waveform. Accordingly, when the timing at which the ejection droplet of the second drop lands on the medium is later than the timing at which the ejection droplet of the first drop lands on the medium, the printing quality is also deteriorated.

FIG. 11 is a diagram showing the relation between the waveform width and the ejection force when Dp22 has the same time width as avrAL and Dp21 has a time width smaller than avrAL. In this case, Dp22 has a larger ejection force than Dp21. In addition, since the residual vibration generated by Dp21 strengthens with Dp22, the droplet speed ejected by Dp22 becomes faster than the droplet speed ejected by Dp21.

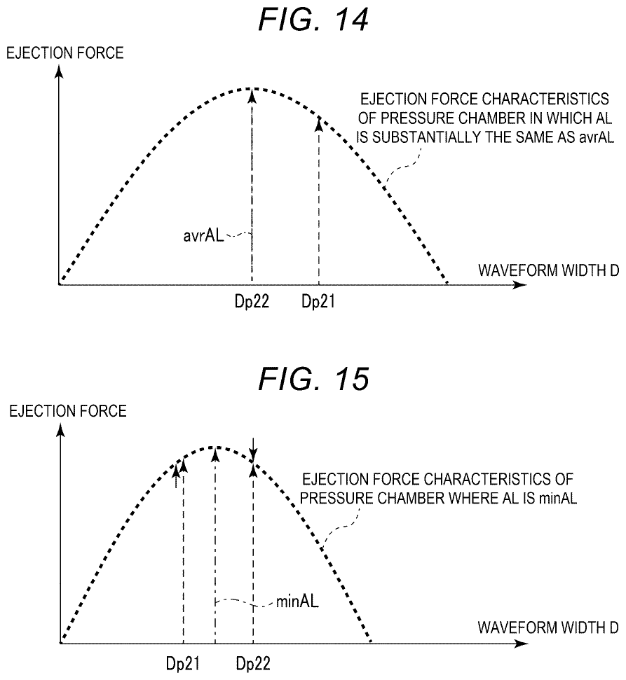

Meanwhile, FIG. 15 shows the relation between the waveform width and the ejection force when a waveform in which Dp22 has the same time width as avrAL and Dp21 has a time width smaller than avrAL is input to the pressure chamber 46 in which AL of the pressure chamber 46 is minAL. In this case, since Dp21 has a waveform width closer to the value of minAL than Dp22, the ejection force of Dp21 increases. In addition, since the difference between the center-to-center distance 2 UL between the ejection waveform of Dp21 and the ejection waveform of Dp22 and 2 AL (2*minAL) of the pressure chamber 46 becomes large, even if Dp22 and the residual vibration strengthen each other, there is a possibility that the droplet speed ejected by Dp22 is slower than the droplet speed ejected by Dp21.

Next, a drive waveform according to an embodiment will be described. For example, in the pressure chamber 46 where AL is approximately 3.0 μs among the plurality of pressure chambers 46, if the drive waveform by which two drops are continuously ejected as shown in FIG. 6 is adjusted and the 2-drop waveform is Dp21=Dp22=2.4 μs, UL=3.0 μs, and Cp=1.5 μs, the speed of the ejection droplet of the second drop of the 2-drop waveform is faster than the speed of the ejection droplet of the first drop of the 2-drop waveform, and the speed of the ejection droplet of the 1-drop waveform is a speed close to the droplet speed of any of the ejection droplets of the 2-drop waveform. More preferably, Dp21=Dp22 is adjusted so that the speed of the combined droplet is substantially the same. In the example of the drive waveform shown in FIG. 6, if the 2-drop waveform is Dp21=Dp22, Dp21 and Dp22 are smaller than AL, but as in the example of the drive waveform shown in FIG. 10, if the 2-drop waveform is Dp21=Dp22, Dp21 and Dp22 may be larger than AL.

As shown in FIG. 6, when the waveform widths of Dp21 and Dp22 are substantially the same, the pressure applied to the liquid in the pressure chamber 46 by each ejection waveform is the same. In addition, by setting the center-to-center interval between Dp21 and Dp22 to be equal or substantially equal to 2 AL, the residual vibration of the pressure chamber 46 generated by Dp21 and the pressure applied to the liquid in the pressure chamber 46 by Dp22 strengthen each other, and thus the speed of the droplet ejected by Dp22 is usually faster than that of the droplet ejected by Dp21.

FIG. 19 shows the relation between the waveform width and the ejection force when Dp21 and Dp22 in the waveform of FIG. 6 have a time width smaller than minAL. The relation is also shown in FIGS. 21 and 23.

In FIGS. 19, 21, and 23, the ejection forces of Dp22 and Dp21 are equivalent. In the waveform of FIG. 6, the residual vibration generated by Dp21 strengthens with Dp22, so that the droplet speed ejected by Dp22 becomes equal to or faster than the droplet speed ejected by Dp21.

Next, the conditions under which the residual vibration of the pressure chamber 46 generated by Dp21 and the pressure applied to the liquid in the pressure chamber 46 by Dp22 strengthen each other will be specifically described with the drawings. In one embodiment, the waveform widths of the ejection waveform of the second drop and the ejection waveform of the first drop are set to be substantially the same. In order to make the speed of the ejection droplet of the 1-drop waveform and the speed of the ejection droplet of the 2-drop waveform substantially the same, Dp21 and Dp22 are set to be smaller than the average value 3.0 μs of the half cycle AL of the main acoustic vibration frequency of the plurality of pressure chambers 46.

Here, when the 1-drop ejection waveform is the waveform as shown in FIG. 9, the residual vibrations are not strengthened. Therefore, when a voltage height or amplitude of the ejection waveform is the same between the 1-drop ejection waveform and a plural-drop ejection waveform, in order to obtain the same ejection speed as that of the plural-drop ejection waveform, it is necessary to set an ejection waveform width with a large ejection force in the 1-drop ejection waveform. For example, the ejection waveform width of one drop is desirably set between minAL and maxAL to increase the ejection force.

In this case, for example, a case in which the waveform width of each ejection waveform of a plurality of drops is set to minAL is considered. In the pressure chamber 46 in which AL is minAL, the ejection force of the plural-drop waveform in which an ejection width is minAL is larger than that of the 1-drop waveform in which the ejection width is the average AL. In addition, since the residual vibrations are strengthened, the ejection speed of a plurality of drops of droplets may be extremely faster than that of a droplet of one drop.

When the waveform width of each ejection waveform of the plurality of drops is set between minAL and maxAL, for example, the same concern as above occurs in any pressure chamber 46 in which AL is between minAL and maxAL. Therefore, it is desirable to set the waveform width of each ejection waveform of the plurality of drops smaller than minAL or larger than maxAL.

Here, for convenience of description, in FIG. 6, the first to second potential difference changes in the ejection waveform of the first drop are described as (1) to (2), and the first to second potential difference changes in the ejection waveform of the second drop are described as (21) to (22). The reference point of the phase of the ejection waveform of the first drop is (0), and the reference point of the phase of the ejection waveform of the second drop is (0″). Here, the reference point (0) of the phase of the ejection waveform of the first drop is an intermediate point between (1) and (2) of the potential difference change, and the reference point (0″) of the phase of the ejection waveform of the second drop is an intermediate point between (21) and (22) of the potential difference change. A voltage drop time tf in (21) of FIG. 6 is substantially the same as a voltage rise time tr of (22). The amount in the potential difference change in (1) and (21) and the amount in the potential difference change in (2) and (22) (the change amount in the height in FIG. 7) are set to be substantially the same. In the present example, the pressure chamber 46 is pressurized by tr, and the pressure chamber 46 is depressurized by tf.

Here, for the sake of simplicity, a vibration attenuation due to a viscous resistance of the flow path or the like is ignored, a time when potential difference change due to tr is generated is set as tin, a time at a phase reference point (0) is defined as t0, and the pressure vibration of the pressure chamber 46 due to pressurization is schematically represented by cos((t0−tin)*(π/AL)). A liquid speed in a nozzle portion is −sin((t0−tin)*(π/AL)). In a head flow path diagram, the nozzle is oriented downward and a liquid speed in the nozzle portion changes downward due to the pressurization of the pressure chamber 46, and thus a minus sign is added. In addition, a time when the potential difference change due to tf is generated is set as tin, and the pressure vibration of the pressure chamber 46 due to depressurization is schematically represented by cos(−π +(t0 −tin)*(π/AL)). The liquid speed in the nozzle portion is −sin(−π +(t0−tin)*(π/AL)). In the head flow path diagram, the nozzle is oriented downward and a liquid speed in the nozzle portion changes upward due to the depressurization of the pressure chamber 46, and thus a minus sign is added.

Thereafter, basically, the phase reference point (0) or (0″) is used as a reference, and an elapsed time (a phase progress) from the occurrence time of a step input of each voltage to the reference point is substituted into (t0−tin). Accordingly, the phase of each potential difference change or its combined wave with respect to the reference point (0) or (0″) will be described.

The main acoustic vibration of the ejection waveform of FIG. 6 will be described. In the ejection waveform by which the first drop is ejected in FIG. 6, if the potential difference change is performed and a voltage for expanding the pressure chamber 46 is input as shown in (1), the pressure chamber 46 is expanded with the potential difference of (1), and the pressure chamber 46 is depressurized. The vibration generated accordingly is a vibration whose phase is advanced by −π+Dp21/2*(π/AL).

The potential difference change (2) for contraction of the pressure chamber 46 are opposite changes for the potential difference to the potential difference change (1) for expansion, and the pressure chamber 46 contracts and pressurizes the inside of the pressure chamber 46. Therefore, (2) is a vibration whose phase is advanced by −Dp21/2*(π/AL).

Here, assuming the combined wave of (1) and (2) at the time point (0), the combined wave of (1) and (2) is a vibration whose phase is advanced by −π/2.

Next, the main acoustic vibration of the ejection waveform of the second drop in FIG. 6 will be described. If the potential difference change is performed and the voltage for expanding the pressure chamber 46 is input as shown in (21), the pressure chamber 46 is expanded by the potential difference of (21) and the inside of the pressure chamber 46 is depressurized, and thus when the ejection waveform width of the second drop is Dp22, the vibration is advanced in phase by −π+Dp22/2*(π/AL).

The potential difference change (22) for contraction of the pressure chamber 46 are opposite changes for the potential difference to the potential difference change (21) for expansion, and the pressure chamber 46 contracts and pressurizes the inside of the pressure chamber 46. Therefore, (22) is a vibration whose phase is advanced by −Dp22/2*(π/AL).

Here, assuming the combined wave of (21) and (22) at the time point (0″), the combined wave of (21) and (22) is a vibration whose phase is advanced by −π/2.

Therefore, when the phase difference between (0) and (0″) is set to an even multiple of π (AL in the case of the time interval), the combined wave of (1) and (2) and the combined wave of (21) and (22) have the same phase and strengthen each other. In the example of FIG. 6, the time difference 2 UL (i.e., the time interval) between (0) and (0″) is 2 AL.

Here, the condition of the time difference between (0) and (0″) in which the amplitudes of the combined wave of (1) and (2) and the combined wave of (21) and (22) are strengthened is considered. If the time difference 2 UL between (0) and (0″) is larger than 1.5 AL and less than 2.5 AL, the combined wave of (1) and (2) and the combined wave of (21) and (22) strengthen each other.

As described above, the half cycles AL of the main acoustic vibration frequencies of the plurality of pressure chambers 46 are not the same due to manufacturing variations. Here, the maximum value of the half cycle AL of the main acoustic vibration frequency of the plurality of pressure chambers 46 is maxAL, and the minimum value is minAL. In this case, the value when 1.5 AL is the largest in the plurality of pressure chambers 46 is 1.5 maxAL, and the value when 2.5 AL is the smallest is 2.5 minAL. Therefore, 2 UL satisfying 1.5 AL≤1.5 maxAL<2 UL<2.5 minAL≤2.5 AL may be set to the time difference between (0) and (0″). Therefore, when the time difference 2 UL between (0) and (0″) of the 2-drop waveform is set to be larger than 1.5 maxAL and smaller than 2.5 minAL, the phase difference between the combined wave of (1) and (2) and the combined wave of (21) and (22) is less than ±90 degrees in all of the plurality of pressure chambers 46, and the combined wave of (1) and (2) and the combined wave of (21) and (22) strengthen each other.

Since the time widths Dp21 of (1) and (2) and the time widths Dp22 of (21) and (22) are substantially the same, even if the half cycle AL of the main acoustic vibration frequency of the pressure chamber 46 is different from the waveform UL, the pressure applied to the liquid in the corresponding pressure chamber 46 by the ejection waveform of the time widths Dp21 and Dp22 is the same. In addition, the ejection speed of the second drop ejected by the strengthening of the residual vibration due to the combined wave of (1) and (2) and the combined wave of (21) and (22) is faster than the ejection speed of the first drop. As described above, by the multi-drop drive waveform by which a plurality of droplets of inks are continuously ejected, in all of the plurality of pressure chambers 46, it is possible to adjust the ejection speed of the ink ejected later by the residual vibration generated by the previous ejection waveform to be equal to or faster than the ejection speed of the previously ejected droplets.

The 1-drop waveform shown in FIG. 9 is the same as the 2-drop waveform in the time of tf and tr and the voltage height of the ejection waveform, and the 1-drop waveform may be a waveform completely different from the 2-drop waveform. In this case, it is also necessary to reduce the difference in droplet speed ejected from the same nozzle between the 1-drop waveform and the 2-drop waveform in order to maintain the printing quality. In this case, the time width Dp21 (=Dp22) of the 2-drop waveform in the embodiment may be adjusted so that the speed of each droplet of the 2-drop waveform (or the speed of the droplet obtained by combining the droplets ejected by Dp21 and Dp22) shown in FIG. 9 is close to the droplet speed of a waveform different from the 1-drop waveform.

Even when it is desirable to set Dp21 and Dp22 to different values in order to finely adjust each droplet speed of the 2-drop waveform, it is desirable to set Dp21 and Dp22 to values as close as possible so that the pressure on the liquid in the pressure chamber 46 by Dp21 and Dp22 becomes close. For example, the time difference between Dp21 and Dp22 is desirably the minimum time difference (other than a time difference of zero) that can be set in the drive circuit 70 that generates the drive waveform.

For example, if the 2-drop waveform is Dp21=Dp22=2.4 μs, UL=3.0 μs, and Cp=1.5 μs, a speed of a combined droplet by the 2-drop waveform is faster than a speed of the ejection droplet of the 1-drop waveform, and if the 2-drop waveform is Dp21=Dp22=2.3 μs, UL=3.0 μs, and Cp=1.5 μs, a speed of the combined droplet by the 2-drop waveform is slower than the speed of the ejection droplet of the 1-drop waveform.

In the drive circuit 70 of the corresponding liquid ejection head 1, when the values of Dp21 and Dp22 cannot be set to values between 2.3 μs and 2.4 μs, for example, Dp21=2.3 μs, Dp22=2.4 μs, UL=3.0 μs, and Cp=1.5 μs is set.

Next, as an example of the multi-drop waveform, a time interval 2 UL between ejection waveforms of two drops adjacent to each other in a 3-drop waveform will be described.

As shown in FIG. 8, even in the drive waveform by which droplets of three drops are ejected, if the time difference between (0) and (0″) is set to be larger than 1.5 maxAL and smaller than 2.5 minAL, the phase difference between the combined of (1) and (2) and the combined wave of (21) and (22) is less than ±90 degrees in all of the plurality of pressure chambers 46, and the combined wave of (1) and (2) and the combined wave of (21) and (22) (the vibration of the liquid in the pressure chamber 46) strengthen each other. If the time difference between (0″) and (0″') is set to be larger than 1.5 maxAL and smaller than 2.5 minAL, the phase difference between the combined wave of (21) and (22) and the combined wave of (31) and (32) is less than ±90 degrees in all of the plurality of pressure chambers 46, and the combined wave of (21) and (22) and the combined wave of (31) and (32) strengthen each other.

By setting Dp31 (=Dp32=Dp33) and adjusting the time width of Dp31 (=Dp32=Dp33), even if the half cycle AL of the main acoustic vibration frequency of the pressure chamber 46 is different from the waveform UL, the pressure applied to the liquid in the corresponding pressure chamber 46 by the ejection waveforms of the time widths of Dp31, Dp32, and Dp33 is the same. In addition, the ejection speed of the second drop ejected by the strengthening of the residual vibration due to the combined wave of (1) and (2) and the combined wave of (21) and (22) is faster than the ejection speed of the first drop. In addition, the ejection speed of the third drop ejected by strengthening the residual vibration due to the combined wave of (21) and (22) and the combined wave of (31) and (32) is faster than the ejection speed of the second drop. As described above, by the multi-drop drive waveform by which a plurality of droplets are continuously ejected, in all of the plurality of pressure chambers 46, it is possible to adjust the ejection speed of the ink ejected later by the residual vibration generated by the previous ejection waveform to be equal to or faster than the ejection speed of the previously ejected droplets.

In the embodiment, as shown in FIGS. 9 and 6, the 1-drop waveform and the 2-drop waveform have the same times tf and tr and voltage heights of the ejection waveform as those of the 3-drop waveform in FIG. 8, and the 1-drop waveform and the 2-drop waveform may be completely different waveforms. Even in this case, in order to maintain the printing quality, it is necessary to reduce the difference in droplet speed ejected from the same nozzle between the 1-drop waveform, the 2-drop waveform, and the 3-drop waveform. Here, it is assumed that the 1-drop waveform and the 2-drop waveform are adjusted to reduce the difference in droplet speed ejected from the same nozzle. The time width Dp31 (=Dp32=Dp33) of the 3-drop waveform in the embodiment may be adjusted so that the speed of each droplet of the 3-drop waveform or the speed of the droplet obtained by combining the droplets ejected by Dp31, Dp32, and Dp33 is close to the droplet speed of a waveform different from the 1-drop waveform in FIG. 9 or the 2-drop waveform in FIG. 6.

Even when it is desirable to set Dp31, Dp32, and Dp33 to different values in order to finely adjust each droplet speed of the 3-drop waveform, it is desirable to set Dp31, Dp32, and Dp33 to values as close as possible so that the pressure on the liquid in the pressure chamber 46 by Dp31, Dp32, and Dp33 becomes close. For example, the time difference between Dp31, Dp32, and Dp33 is desirably a minimum time difference other than the time difference of zero that can be set in the drive circuit 70 that generates the drive waveform.

For example, if the 3-drop waveform is Dp31=Dp32=Dp33=2.4 μs, UL=3.0 μs, and Cp=1.5 μs, a speed of a combined droplet by the 3-drop waveform is faster than a speed of the ejection droplet of the 1-drop waveform, and if the 3-drop waveform is Dp31=Dp32=Dp33=2.3 μs, UL=3.0 μs, and Cp=1.5 μs, a speed of the combined droplet by the 3-drop waveform is slower than the speed of the ejection droplet of the 1-drop waveform.

In the drive circuit 70 of the corresponding liquid ejection head 1, when the values of Dp31, Dp32, and Dp33 cannot be set to values between 2.4 μs and 2.3 μs, for example, Dp31=Dp32=2.3 μs, Dp33=2.4 μs, UL=3.0 μs, and Cp=1.5 μs are set. Alternatively, Dp31=2.3 μs, Dp32=Dp33=2.4 μs, UL=3.0 μs, and Cp=1.5 μs are set.

In addition, even in the drive waveform by which n drops are ejected, if the reference point of the phase of the ejection waveform of any one of the ejection waveforms from the first to (n−1)-th drops is set to (0) and the reference point of the phase of the ejection waveform of the next drop is set to (0″), and the time difference between (0) and (0″) is set to be larger than 1.5 maxAL and smaller than 2.5 minAL, in all of the plurality of pressure chambers 46, all the ejection waveforms which are ejected after the second drop are strengthened with the residual vibration of the previous ejection waveform. In addition, by setting all the ejection waveform widths to Dpn1 (=Dpn2=. . . =Dpnn) and adjusting the time width of Dpn1 (=Dpn2=. . . =Dpnn), even if the half cycle AL of the main acoustic vibration frequency of the pressure chamber 46 is different from the waveform UL, the ejection waveforms having the time widths of Dpn1, Dpn2, and Dpnn apply the same pressure to the liquid in the corresponding pressure chamber 46. As described above, by the multi-drop drive waveform by which a plurality of droplets of inks are continuously ejected, in all of the plurality of pressure chambers 46, it is possible to adjust the ejection speed of the ink ejected later by the residual vibration generated by the previous ejection waveform to be equal to or faster than the ejection speed of the previously ejected droplets.

The n-drop waveform and the ejection waveform of the drive waveform by which a number of drops other than n are ejected may be completely different waveforms. In this case, in order to maintain the printing quality, it is also necessary to reduce the difference in droplet speed ejected from the same nozzle between the n-drop waveform and the drive waveform by which a number of drops other than n are ejected. Here, it is assumed that the drive waveforms by which a number of drops other than n are ejected are adjusted to reduce the difference in droplet speed ejected from the same nozzle. The time width Dpn1 (=Dpn2=. . . =Dpnn) of the n-drop waveform in the embodiment may be adjusted such that the speed of each droplet of the n-drop waveform or the speed of the droplet obtained by combining the droplets ejected by Dpn1 to Dpnn is close to the droplet speed of the drive waveform by which a number of drops other than n are ejected. In addition, in the drive waveform for ejecting a plurality of drops, when a passage of time after ejection is short, there are a plurality of droplets before combination. A satellite may occur after a plurality of droplets. When comparing the droplet speeds of the drive waveforms having different numbers of drops before a plurality of droplets are combined, the time width Dpn1 (=Dpn2=. . . =Dpnn) of the n-drop waveform may be adjusted so that the speed of the droplets having a largest volume (a largest droplet diameter) among the droplets ejected by the n-drop waveform and the speed of the droplets having a largest volume (a largest droplet diameter) among the droplets ejected by the drive waveform for ejecting the number of drops other than n become close (more preferably, substantially equal).

Even when it is desired to set Dpn1, Dpn2,. . . Dpnn to different values in order to finely adjust the droplet speed of the n-drop waveform, Dpn1 to Dpnn are desirably set to values as close as possible so that the pressures of Dpn1 to Dpnn to the liquid in the pressure chamber 46 are close to each other. For example, the time difference between Dpn1, Dpn2, . . . , and Dpnn is desirably a minimum time difference (other than the time difference of zero) that can be set in the drive circuit that generates the corresponding drive waveform.

In the example described above, the liquid ejection head 1 that outputs a drive waveform having the ejection waveform as a rectangular wave is described, and the embodiment is not limited thereto. For example, the ejection waveform may be a waveform having an intermediate voltage. Hereinafter, as another embodiment, an example of the liquid ejection head 1 that outputs a drive waveform having an intermediate voltage will be described. In the embodiment, configurations same as those in the above-described embodiments are denoted by the same reference numerals, and a detailed description thereof will be omitted.

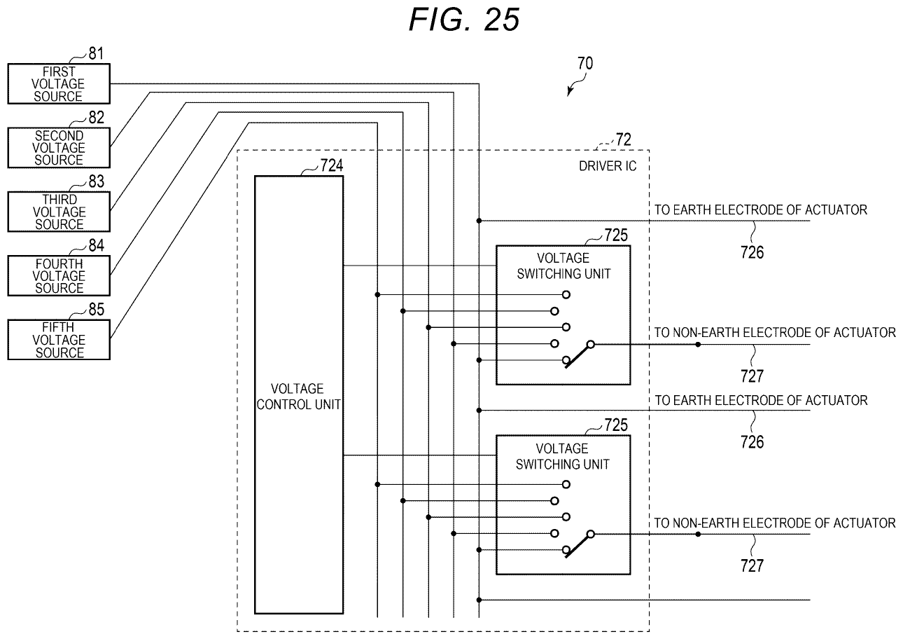

First, the drive circuit 70 of the liquid ejection head 1 will be described with reference to FIG. 25. As shown in FIG. 25, in the drive circuit of the liquid ejection head 1 according to another embodiment, the drive circuit 70 includes, for example, the voltage control unit 724 and the same number of voltage switching units 725 as the pressure chambers 46 in the driver IC 72. However, in FIG. 25, two voltage switching units 725 are shown, and other voltage switching units 725 are not shown.

The drive circuit 70 is connected to the first voltage source 81, the second voltage source 82, the third voltage source 83, a fourth voltage source 84, and a fifth voltage source 85. The drive circuit 70 applies a voltage supplied from the first voltage source 81 to each wiring electrode 726. The drive circuit 70 selectively applies, to wiring electrodes 727, the voltages supplied from the first voltage source 81, the second voltage source 82, the third voltage source 83, the fourth voltage source 84, and the fifth voltage source 85. Here, if the actuator 20 is a laminated PZT, since there is a tendency to deteriorate when a bipolar voltage is applied, the voltages supplied by the first voltage source 81, the second voltage source 82, the third voltage source 83, the fourth voltage source 84, and the fifth voltage source 85 are set to a ground voltage and either positive or negative with respect to the ground voltage.

An output voltage of the first voltage source 81 is, for example, a ground voltage, and a voltage value thereof is V0 (V0=0 [V]). A voltage value indicated by the output voltage of the second voltage source 82 is V1. The voltage value V1 is higher than V0. A voltage value indicated by the output voltage of the third voltage source 83 is, for example, V2. For example, the voltage value V2 is higher than V0 and lower than V1. A voltage value indicated by the output voltage of the fourth voltage source 84 is V3. The voltage value V3 is lower than V0. A voltage value of the output voltage of the fifth voltage source 85 is, for example, V4. For example, the voltage value V4 is lower than V0 and higher than V3.

The wiring electrode 726 is connected to a common electrode as an earth electrode of the actuator 20. Each of the plurality of wiring electrodes 727 is connected to an individual electrode as a non-earth electrode of the actuator 20.

The voltage control unit 724 is connected to each of the plurality of voltage switching units 725. The voltage control unit 724 outputs, to each voltage switching unit 725, a command indicating which voltage source among the first voltage source 81, the second voltage source 82, the third voltage source 83, the fourth voltage source 84, and the fifth voltage source 85 is selected. For example, the voltage control unit 724 receives an image signal from the control unit 150 and determines a switching timing of the voltage source in each voltage switching unit 725. Further, the voltage control unit 724 outputs the command to select any one of the first voltage source 81, the second voltage source 82, the third voltage source 83, the fourth voltage source 84, and the fifth voltage source 85 to the voltage switching unit 725 at a determined switching timing. The voltage switching unit 725 switches the voltage source connected to the wiring electrode 727 according to the command from the voltage control unit 724.

The voltage switching unit 725 includes, for example, a semiconductor switch. The voltage switching unit 725 connects any one of the first voltage source 81, the second voltage source 82, the third voltage source 83, the fourth voltage source 84, and the fifth voltage source 85 to the wiring electrode 727 under the control of the voltage control unit 724. Therefore, the internal electrodes of different poles of the piezoelectric pillar 21 are connected to the wiring electrode 726 and the wiring electrode 727 via the external electrodes (i.e., the common electrode and the individual electrode).

In the drive circuit 70, the connection wiring between the voltage sources 81, 82, 83, 84, and 85 and the actuator 20 is switched by a switching circuit including the voltage control unit 724 and the plurality of voltage switching units 725, so that a drive waveform having at least three types of potential differences is input between the electrodes of the actuator 20 as a drive signal. Here, the drive waveform is an ejection waveform by which droplets are ejected by driving the actuator 20. Here, a potential difference other than the largest potential difference and the smallest potential difference is referred to as an intermediate potential difference.

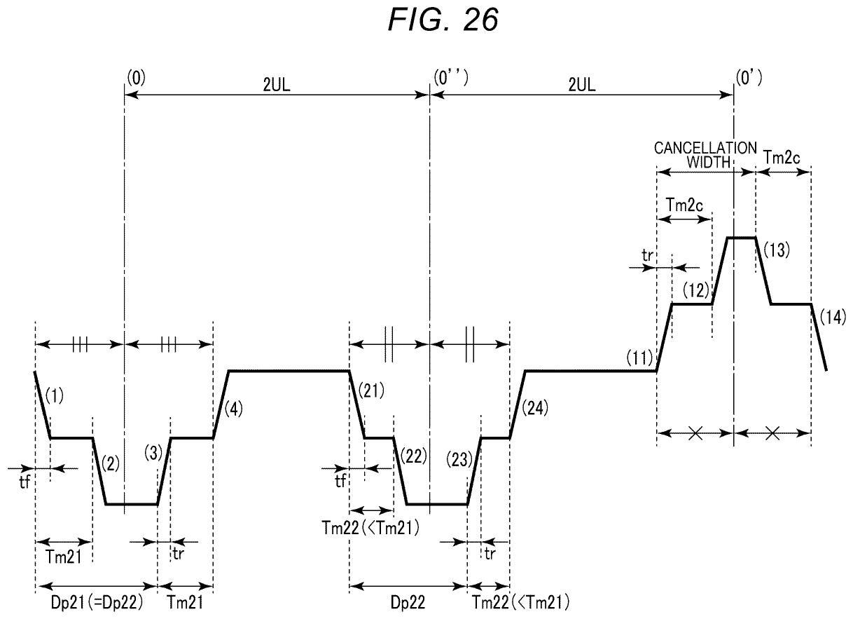

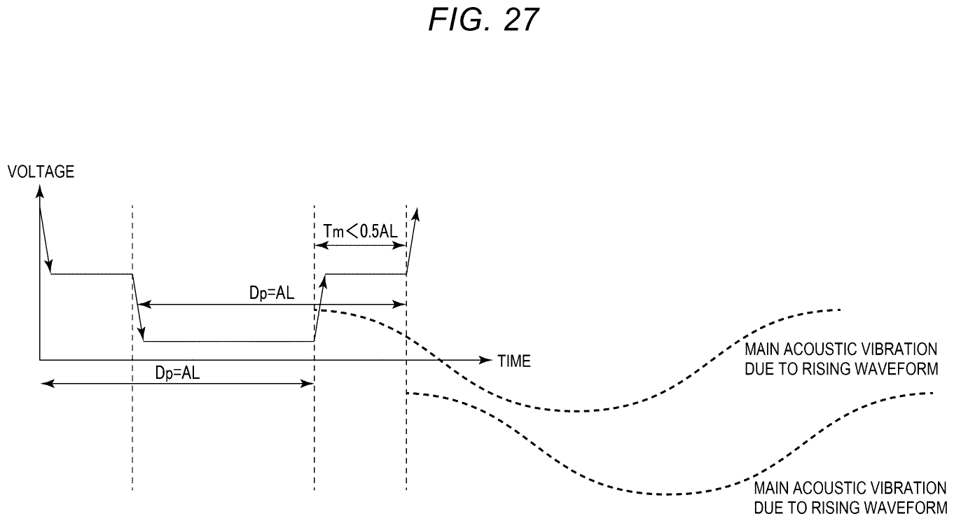

FIG. 26 shows an example of the drive waveform in which the ejection waveform is continuously input twice at predetermined intervals when the liquid ejection head 1 ejects the ink. FIG. 27 shows an example of the ejection waveform. In FIGS. 26 and 27, a vertical axis represents a voltage (or a potential difference), and a horizontal axis represents a time. The drive waveform is generated by the driver IC 72 of the drive circuit 70. As shown in FIG. 26, in the drive waveform, in both the two ejection waveforms and the cancel waveform, the expansion potential difference is reduced twice when the pressure chamber 46 is expanded, and the contraction potential difference is increased twice when the pressure chamber 46 is contracted during ejection. When the potential difference is changed both when the pressure chamber 46 is expanded and when the pressure chamber is contracted, after a first potential difference is applied, the first potential difference is maintained for a predetermined time, and then a second potential difference is applied. When the pressure chamber 46 is expanded when the voltage is reduced, the voltage is increased in order to contract the pressure chamber 46 in advance before the ejection waveform is input.

First, an example of the ejection waveform of the first drop among the drive waveforms will be specifically described with reference to FIGS. 26 and 27. As shown in FIG. 27, when the pressure chamber 46 is expanded in advance before the ink is ejected, a time interval from a first expansion start time point due to the expansion potential difference when the potential difference is continuously reduced twice to a first contraction start time point due to the contraction potential difference after the potential difference is continuously reduced twice by the expansion potential difference is set as Dp. In addition, as shown in FIG. 27, when the pressure chamber 46 is contracted during ejection, a time interval from a second expansion start time point due to the expansion potential difference when the potential difference is continuously reduced twice before the potential difference is increased to a second contraction start time point due to the contraction potential difference when the potential difference is continuously reduced twice by the expansion potential difference and then continuously increased twice by the contraction potential difference is set as Dp.

The time width Dp is larger than 0.5AL and less than 1.5 AL. More preferably, Dp=AL. This is because if Dp is set to be larger than 0.5 AL and less than 1.5 AL, the main acoustic vibration generated by expanding the pressure chamber 46 in advance before ejection and the main acoustic vibration generated by contracting the pressure chamber 46 during ejection strengthen each other.

In addition, when the time width Tm is smaller than 0.5 AL, the main acoustic vibrations by the two rising waveforms in FIG. 27 strengthen each other. By adjusting the time width Tm, it is possible to adjust the strengthening of the main acoustic vibration by the two rising waveforms, and to adjust the ejection force of the droplet by the ejection waveform of FIG. 27. By setting Tm to be smaller than 0.5 minAL, the main acoustic vibrations by the two rising waveforms in FIG. 27 are strengthened in all of the plurality of pressure chambers 46 to which the same drive waveform is input.

In the drive waveform of FIG. 26, since the Tm22 of the ejection waveform of the second drop is smaller than the Tm21 of the ejection waveform of the first drop, the strengthening of the main acoustic vibration by the rising waveforms of (23) and (24) is larger than that of (3) and (4). The strengthening of the main acoustic vibration by the falling waveforms of (21) and (22) is also larger than that of (1) and (2). Since Dp21 is the same as Dp22, the strengthening of the main acoustic vibrations of (1) and (3) is the same as that of (21) and (23). The strengthening of the main acoustic vibration of (2) and (4) is the same as that of (22) and (24). Therefore, even if the pressure chambers 46 having different AL in the waveform of FIG. 26 are driven, a magnitude relation between the ejection forces, that is, the ejection force of the second drop ejection waveform is larger than the ejection force of the ejection waveform of the first drop, remains unchanged. Therefore, the ejection speed of the second drop is faster than that of

### The First Drop.

In the drive waveform of FIG. 26, a speed difference between the first drop and the second drop in the waveform of FIG. 26 is adjusted by adjusting Tm21 and Tm22 in a range smaller than 0.5 minAL. By adjusting the magnitude of Dp21=Dp22, it is possible to make the speed substantially the same as that of the droplets ejected by other drive waveforms having different ejection volumes.

Here, for convenience of description, in FIG. 26, the first to fourth potential difference changes in the ejection waveform of the first drop are described as (1) to (4), and the first to fourth potential difference changes in the ejection waveform of the second drop are described as (21) to (24). The reference point of the phase of the ejection waveform of the first drop is (0), and the reference point of the phase of the ejection waveform of the second drop is (0″). Here, the reference point (0) of the phase of the ejection waveform of the first drop is an intermediate point between (2) and (3) of the potential difference change, and the reference point (0″) of the phase of the ejection waveform of the second drop is an intermediate point between (22) and (23) of the potential difference change. The voltage drop time tf in FIG. 26 is substantially the same as the voltage rise time tr in FIG. 26. The amount in the potential difference change in (1), (2), (21), and (22) and the amount in the potential difference change in (3), (4), (23), and (24) (the change amount in the height in FIG. 26) are set to be substantially the same.

The main acoustic vibration of the ejection waveform of the first drop shown in FIG. 26 will be described. As shown in FIG. 26, in the ejection waveform by which the first drop is ejected, if the potential difference change is performed and the voltage for expanding the pressure chamber 46 is input as shown in (1), the pressure chamber 46 is expanded with the potential difference of (1), and the pressure chamber 46 is depressurized. The vibration generated accordingly is a vibration whose phase is advanced by −π+(Dp21+Tm21)/2*(π/AL). Further, if the potential difference change shown in (2) is performed, in (2), the vibration is advanced in phase by −π+(Dp21 Tm21)/2*(π/AL). The combined wave of (1) and (2) is a vibration whose phase is advanced by −π+Dp21/2*(π/AL).

The potential difference changes (3) and (4) for contraction of the pressure chamber 46 are opposite changes for the potential difference to the potential difference changes (1) and (2) for expansion, and the pressure chamber 46 contracts and pressurizes the inside of the pressure chamber 46. Therefore, (3) is a vibration whose phase is advanced by −(Dp21−Tm21)/2*(π/AL). In addition, (4) can be considered as a vibration whose phase is advanced by −(Dp21+Tm21)/2*(π/AL). Therefore, the combined wave of (3) and (4) is a vibration whose phase is advanced by −Dp21/2*(π/AL).

Here, assuming the combined wave of (1), (2), (3), and (4) at the time point (0), the combined wave of (1), (2), (3), and (4) is a vibration whose phase is advanced by −π/2.

Next, the main acoustic vibration of the ejection waveform of the second drop in FIG. 26 will be described. If the potential difference change is performed and the voltage for expanding the pressure chamber 46 is input as shown in (21), the pressure chamber 46 is expanded by the potential difference of (21) and the inside of the pressure chamber 46 is depressurized, and thus when the ejection waveform width of the second drop is Dp22, the vibration is advanced in phase by −π+(Dp22+Tm22)/2*(π/AL). Further, when the potential difference change shown in (22) is performed, in (22), it can be considered that the vibration is advanced in phase by −π+(Dp22−Tm22)/2*(π/AL). Therefore, the combined wave of (21) and (22) is a vibration whose phase is advanced by −π+Dp22/2*(π/AL).

The potential difference changes (23) and (24) for contraction of the pressure chamber 46 are opposite changes for the potential difference to the potential difference changes (21) and (22) for expansion, and the pressure chamber 46 contracts and pressurizes the inside of the pressure chamber 46. Therefore, (23) is a vibration whose phase is advanced by −(Dp22−Tm22)/2*(π/AL). In addition, (24) is a vibration whose phase is advanced by −(Dp22+Tm22)/2*(π/AL). Therefore, the combined wave of (23) and (24) is a vibration whose phase is advanced by −Dp22/2*(π/AL).

Here, assuming the combined wave of (21), (22), (23), and (24) at the time point (0″), the combined wave of (21), (22), (23), and (24) is a vibration whose phase is advanced by −π/2.

Therefore, when the phase difference between (0) and (0″) is set to an even multiple of π (AL in the case of the time interval), the combined wave of (1), (2), (3), and (4) and the combined wave of (21), (22), (23), and (24) have the same phase and strengthen each other. In the shown example, the time difference (i.e., the time interval) between (0) and (0″) is 2 AL.

Here, the condition of the time difference between (0) and (0″) in which the amplitudes of the combined wave of (1), (2), (3), and (4) and the combined wave of (21), (22), (23), and (24) are strengthened is considered. If the time difference 2 UL between (0) and (0″) is larger than 1.5 AL and less than 2.5 AL, the combined wave of (1), (2), (3), and (4) and the combined wave of (21), (22), (23), and (24) strengthen each other.

Further, in the liquid ejection head 1, the half cycles AL of the main acoustic vibration frequencies of the plurality of pressure chambers 46 are not the same due to manufacturing variations. Here, the maximum value of the half cycle AL of the main acoustic vibration frequency of the plurality of pressure chambers 46 is maxAL, and the minimum value is minAL. In this case, the value when 1.5 AL is the largest in the plurality of pressure chambers 46 is 1.5 maxAL, and the value when 2.5 AL is the smallest is 2.5 minAL. Therefore, 2 UL satisfying 1.5 AL≤1.5 maxAL<2 UL<2.5 minAL≤2.5 AL may be set to the time difference between (0) and (0″). Therefore, when the time difference 2 UL between (0) and (0″) of the 2-drop waveform shown in FIG. 26 is set to be larger than 1.5 maxAL and smaller than 2.5 minAL, the phase difference between the combined wave of (1), (2), (3), and (4) and the combined wave of (21), (22), (23), and (24) is less than ±90 degrees in all of the plurality of pressure chambers 46, and the combined wave of (1), (2), (3), and (4) and the combined wave of (21), (22), (23), and (24) strengthen each other.

As described above, even if the half cycle AL of the main acoustic vibration frequency of the pressure chamber 46 is different from the waveform UL, the ejection force of the ejection waveform of the second drop in the drive waveform of FIG. 26 is larger than the ejection force of the ejection waveform of the first drop. In addition, the ejection speed of the second drop ejected by the strengthening of the residual vibration due to the combined wave of (1), (2), (3), and (4) and the combined wave of (21), (22), (23), and (24) is faster than the ejection speed of the first drop. As described above, by the multi-drop drive waveform shown in FIG. 26 in which a plurality of droplets of inks are continuously ejected, in all of the plurality of pressure chambers 46, it is possible to adjust the ejection speed of the ink ejected later by the residual vibration generated by the previous ejection waveform to be equal to or faster than the ejection speed of the previously ejected droplets.

Although the case of two drops is shown in FIG. 26, also in the drive waveform by which droplets of three drops or more are ejected, by making Dp widths of all the ejection waveforms the same and making an intermediate voltage time of the ejection waveform of a subsequent ejection droplet smaller than that of the previous ejection waveform within a range smaller than 0.5minAL, in all the plurality of pressure chambers 46, it is possible to adjust the ejection speed of the ink ejected later by the residual vibration generated by the previous ejection waveform to be equal to or faster than the ejection speed of the previously ejected droplet. This is because, as an intermediate voltage time Tm is shorter, for example, the strengthening of the main acoustic vibrations by the rising waveform and the falling waveform shown in FIG. 27 increases. Here, it is assumed that an intermediate voltage time of a first ejection waveform of the n-drop waveform is Tmn1, an intermediate voltage time of a last ejection waveform is Tmnn, and numbers are assigned in order from Tmn1 to Tmnn. When any time of Tm among Tmn1 to Tmnn is made shorter than the previous Tm in order to adjust the ejection speed of the droplet, it is desirable to make the subsequent Tm equal to or shorter than the time of the any Tm in order to maintain the speed of the droplet or to increase the speed of the droplet according to the subsequent ejection waveform. In this case, the last Tm (=Tmnn) is shorter than the first Tm (=Tmn1). By adjusting Dp width while making Dp widths of all the ejection waveforms the same, it is possible to make the speed substantially the same as that of the droplets ejected by other drive waveforms having different ejection volumes.

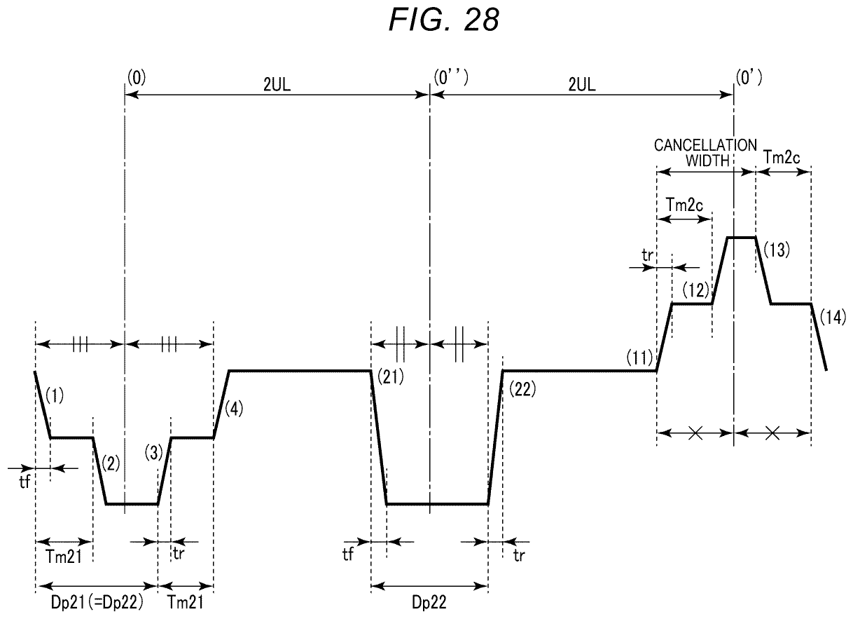

Next, an example of a drive waveform according to another embodiment will be described with reference to FIG. 28. The drive waveform of FIG. 28 is a waveform in which Tm22 of the drive waveform of FIG. 26 is a zero value. In the waveform of FIG. 28, it can be considered that the Tm22 of the ejection waveform for the second drop is a zero value and smaller than the Tm21 of the ejection waveform of the first drop, and an amplitude of the main acoustic vibration by the rising waveform of (22) is larger than the combined wave of the main acoustic vibrations by the rising waveforms of (3) and (4). The amplitude of the main acoustic vibration by the falling waveform of (21) is larger than the combined wave of the main acoustic vibration by the falling waveforms of (1) and (2). Since Dp21 is the same as Dp22, the amplitude of the main acoustic vibration is larger in the combined wave of (21) and (22) than in the combined wave of (1), (2), (3), and (4). Therefore, even if the pressure chambers 46 having different AL in the waveform of FIG. 28 are driven, a magnitude relation between the ejection forces, that is, the ejection force of the second drop ejection waveform is larger than the ejection force of the ejection waveform of the first drop, remains unchanged. Therefore, the ejection speed of the second drop is faster than that of the first drop.

In the waveform of FIG. 28, a speed difference between the first drop and the second drop in the waveform of FIG. 26 is adjusted by adjusting Tm21 in a range smaller than 0.5 minAL. By adjusting the magnitude of Dp21=Dp22, it is possible to make the speed substantially the same as that of the droplets ejected by other drive waveforms having different ejection volumes.

As described above in the description of the waveform of FIG. 26, assuming the combined wave of (1), (2), (3), and (4) at the time point (0), the combined wave of (1), (2), (3), and (4) is a vibration whose phase is advanced by −π/2.

As described above in the description of the waveform of FIG. 6, assuming the combined wave of (21) and (22) at the time point (0″), the combined wave of (21) and (22) is a vibration whose phase is advanced by −π/2.

Therefore, when the phase difference between (0) and (0″) is set to an even multiple of π (AL in the case of the time interval), the combined wave of (1), (2), (3), and (4) and the combined wave of (21) and (22) have the same phase and strengthen each other. In the example of FIG. 28, the time difference 2 UL (the time interval) between (0) and (0″) is 2 AL.

Here, the condition of the time difference (i.e., the time interval) between (0) and (0″) in which the amplitudes of the combined wave of (1), (2), (3), and (4) and the combined wave of (21) and (22) are strengthened is considered. If the time difference 2 UL between (0) and (0″) is larger than 1.5 AL and less than 2.5 AL, the combined wave of (1), (2), (3), and (4) and the combined wave of (21), (22), (23), and (24) strengthen each other.

Further, in the liquid ejection head 1, the half cycles AL of the main acoustic vibration frequencies of the plurality of pressure chambers 46 are not the same due to manufacturing variations. Here, the maximum value of the half cycle AL of the main acoustic vibration frequency of the plurality of pressure chambers 46 is maxAL, and the minimum value is minAL. In this case, the value when 1.5 AL is the largest in the plurality of pressure chambers 46 is 1.5 maxAL, and the value when 2.5 AL is the smallest is 2.5 minAL. Therefore, 2 UL satisfying 1.5 AL≤1.5 maxAL<2 UL<2.5 minAL≤2.5 AL may be set to the time difference between (0) and (0″). Therefore, when the time difference 2 UL between (0) and (0″) of the 2-drop waveform shown in FIG. 28 is set to be larger than 1.5 maxAL and smaller than 2.5 minAL, the phase difference between the combined wave of (1), (2), (3), and (4) and the combined wave of (21) and (22) is less than ±90 degrees in all of the plurality of pressure chambers 46, and the combined wave of (1), (2), (3), and (4) and the combined wave of (21) and (22) strengthen each other.

Even if the pressure chambers 46 having different AL in the waveform of FIG. 28 are driven, the ejection force of the ejection waveform of the second drop is larger than the ejection force of the ejection waveform of the first drop. In addition, the ejection speed of the second drop ejected by the strengthening of the residual vibration due to the combined wave of (1), (2), (3), and (4) and the combined wave of (21) and (22) is faster than the ejection speed of the first drop. As described above, by the multi-drop drive waveform shown in FIG. 28 in which a plurality of droplets of inks are continuously ejected, in all of the plurality of pressure chambers 46, it is possible to adjust the ejection speed of the ink ejected later by the residual vibration generated by the previous ejection waveform to be equal to or faster than the ejection speed of the previously ejected droplets.

Although the case of two drops is shown in FIG. 28, also in the drive waveform by which droplets of three drops or more are ejected, by making the first few ejection waveforms have an ejection waveform with an intermediate voltage as in the first drop in FIG. 28, making the ejection waveform from the middle to the end an ejection waveform having no intermediate voltage as in the second drop in FIG. 28, making Dp width of all the ejection waveforms the same, and making the intermediate voltage time of the ejection waveform of the subsequent ejection droplet in the ejection waveform having an intermediate voltage smaller than that of the previous ejection waveform within a range of less than 0.5minAL, in all the plurality of pressure chambers 46, it is possible to adjust the ejection speed of the ink ejected later by the residual vibration generated by the previous ejection waveform to be equal to or faster than the ejection speed of the previously ejected droplet. More preferably, only the last ejection waveform is an ejection waveform having no intermediate voltage as in the second drop in FIG. 28, and all the ejection waveforms other than the last are ejection waveforms having an intermediate voltage as in the first drop in FIG. 28. That is, the drive waveform is preferably a drive waveform in which the number of potential difference changes in the first ejection waveform among a plurality of ejection waveforms or in all of the ejection waveforms other than the last ejection waveform is greater than the number of potential difference changes in the last ejection waveform. By adjusting Dp width while making Dp widths of all the ejection waveforms the same, it is possible to make the speed substantially the same as that of the droplets ejected by other drive waveforms having different ejection volumes.

In the example described above, the time difference (center-to-center distance) 2 UL between the adjacent ejection waveforms is set to be greater than 1.5 maxAL and smaller than 2.5 minAL in order to have a cycle in which the residual vibration of the liquid in the pressure chamber 46 generated based on the ejection waveform generated earlier and the vibration of the liquid in the pressure chamber 46 generated subsequently are increased. However, the liquid ejection head 1 is not limited to the configuration.

That is, a drive waveform including a plurality of ejection waveforms is set, and any one of the ejection waveforms after the first drop among the plurality of ejection waveforms is set as an a-th drop, and any one of the ejection waveforms after the first drop is set as a b-th drop. In this case, a time difference 2*(b−a)*UL between centers of an a-th drop ejection waveform and a b-th drop ejection waveform is set to be greater than (2*(b−a)−0.5) times a maximum value (maxAL) of the half cycle AL of the main acoustic vibration frequency of the plurality of pressure chambers 46, a volume of which is varied by the actuator 20 that inputs a drive signal, and smaller than (2*(b−a)+0.5) times a minimum value (minAL) of the half cycle AL. Accordingly, when there are two ejection waveforms or when there are three or more ejection waveforms, the time difference 2 UL between adjacent ejection waveforms is 1.5 maxAL<2 UL<2.5 minAL, as described above. In the case of a drive waveform that includes three or more ejection waveforms, the time difference 2*(b−a)*UL between two ejection waveforms that are not adjacent to each other and have one or more ejection waveforms disposed therebetween is (2*(b−a)−0.5)*maxAL<2*(b−a)*UL<(2*(b−a)+0.5)*minAL. In this way, by setting the time difference between at least any two of the plurality of ejection waveforms contained in the drive waveform to (2*(b−a)−0.5)*maxAL<2* (b−a)*UL<(2*(b−a)+0.5)*minAL, the residual vibration and the ejection waveform strengthen each other for subsequent droplets, increasing the ejection speed.

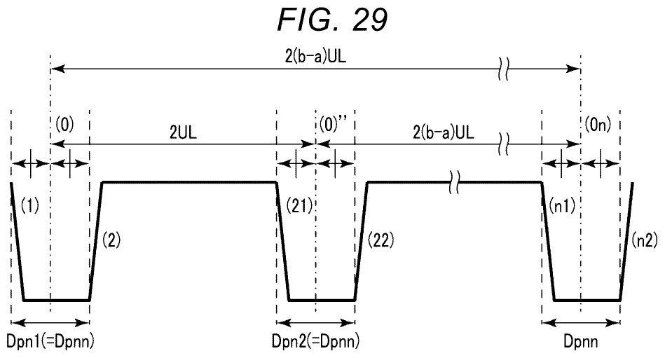

Such a liquid ejection head 1 according to another embodiment will be described with reference to FIGS. 8 and 29. FIG. 29 is a diagram showing an example of a drive waveform by which n drops of droplets are ejected as an example of the drive waveform of the liquid ejection head 1 according to another embodiment.

First, in the drive waveforms shown in FIGS. 8 and 29 by which three or more droplets are ejected, the droplets from the third drop to the n-th drop are affected by the previous ejection waveforms. A specific example will be described below.

For example, in the example of the drive waveform by which three drops of droplets are ejected as shown in FIG. 8, the droplet of the third drop is affected not only by the ejection waveform of the second drop but also by the ejection waveform of the first drop. Therefore, for example, even if the waveform by which the droplet of the second drop is ejected and the waveform by which the droplet of the third drop is ejected are in a mutually strengthening relationship, when the waveform by which the droplet of the first drop is ejected and the waveform by which the droplet of the third drop is ejected are in a weak relationship, an ejection force of the third drop is weakened by the influence of the ejection waveform of the first drop, giving rise to the concern that the speed of the third drop is not sufficiently increased and the third drop does not catch up with the preceding drop.

Therefore, in the 3-drop waveform, the waveform by which the droplet of the first drop is ejected and the waveform by which the droplet of the third drop is ejected may be made to strengthen each other. For example, as shown in FIG. 8, when the time difference between (0) and (0″′) is set to be larger than 3.5 maxAL and smaller than 4.5 minAL, the phase difference between the combined wave of (1) and (2) and the combined wave of (31) and (32) is less than ±90 degrees in all of the plurality of pressure chambers 46. Accordingly, the combined wave of (1) and (2) and the combined wave of (31) and (32) strengthen each other. By setting Dp31 (=Dp32=Dp33) and adjusting the time width of Dp31 (=Dp32=Dp33), even if the half cycle AL of the main acoustic vibration frequency of the pressure chamber 46 is different from the waveform UL, the pressure applied to the liquid in the corresponding pressure chamber 46 by the ejection waveforms of the time widths of Dp31, Dp32, and Dp33 is the same. In addition, the ejection speed of the third drop ejected by strengthening the residual vibration due to the combined wave of (1) and (2) and the combined wave of (31) and (32) is faster than the ejection speed of the first drop.

As shown in FIG. 29, in a drive waveform (n-drop waveform) by which a plurality of n droplets are continuously ejected, an ejection waveform for the a-th drop after the first drop, and an ejection waveform for the b-th drop that is 2 drops after the a-th drop and before the n-th drop are set, and the ejection waveform for the b-th drop is considered. In FIG. 29, a reference point of a phase of an n-th drop ejection waveform is denoted by (0n). In such a drive waveform by which n drops of droplets are ejected, it is considered that the droplet of the b-th drop is affected by the ejection waveform of the a-th drop. When the waveform by which the droplet of the a-th drop is ejected and the waveform by which the droplet of the b-th drop is ejected are in a weak relationship, an ejection force of the b-th drop is weakened by the influence of the ejection waveform of the a-th drop, giving rise to the concern that the speed of the b-th drop is not sufficiently increased and the b-th drop does not catch up with the preceding drop. Therefore, if the reference point of the phase of the ejection waveform of the a-th drop is set to (0a), the reference point of the phase of the ejection waveform of the b-th drop, which is two drops after the ejection waveform of the a-th drop, is set to (0b), and a time difference 4 UL between (0a) and (0b) is set to be larger than 3.5*maxAL and smaller than 4.5*minAL, the residual vibrations of ejection waveform of the a-th drop and the ejection waveform of the b-th drop strengthen each other in all of the plurality of pressure chambers 46.

In a drive waveform (n-drop waveform) by which a plurality of n droplets are continuously ejected, the ejection waveform of the a-th drop after the first drop and the ejection waveform of the b-th drop after the a-th drop and before the n-th drop will be considered. In the drive waveform by which b drops or more of droplets are ejected, it is considered that the droplet of the b-th drop is affected by the ejection waveform of the a-th drop. When the waveform by which the droplet of the a-th drop is ejected and the waveform by which the droplet of the b-th drop is ejected are in a weak relationship, an ejection force of the b-th drop is weakened by the influence of the ejection waveform of the a-th drop, giving rise to the concern that the speed of the b-th drop is not sufficiently increased and the b-th drop does not catch up with the preceding drop. Therefore, if the reference point of the phase of the ejection waveform of the a-th drop is set to (0a), the reference point of the phase of the ejection waveform of the b-th drop is set to (0b), and a time difference 2*(b−a)*UL between (0a) and (0b) is set to be larger than (2*(b−a) 0.5)*maxAL and smaller than (2*(b−a)+0.5)*minAL, the residual vibrations of ejection waveform of the a-th drop and the ejection waveform of the b-th drop strengthen each other in all of the plurality of pressure chambers 46.

In this way, in the n-drop waveform by which the plurality of droplets are ejected, any one of the ejection waveforms after the first drop among the plurality of ejection waveforms is set as the a-th drop, and any one of the ejection waveforms after the a-th drop is set as the b-th drop. Then, in the liquid ejection head 1, by setting the time interval (time difference) 2*(b−a)*UL between the centers of the ejection waveform of the a-th drop and the ejection waveform of the b-th drop to (2*(b−a)−0.5)*maxAL<2*(b−a)*UL<(2*(b−a)+0.5)*minAL, the residual vibration due to the ejection waveform of the previous drop (the a-th drop) and the vibration due to the ejection waveform of the subsequent drop (the b-th drop) strengthen each other, thereby making it possible to increase the ejection speed.

The two ejection waveforms for which the time difference 2*(b−a)*UL is set as (2*(b−a)−0.5)*maxAL<2*(b−a)*UL<(2*(b−a)+0.5)*minAL may be all combinations of two ejection waveforms among the plurality of ejection waveforms of the n-drop waveform, or may be any one or more combinations of all combinations of two ejection waveforms.

Next, when there is variation in the main acoustic vibration frequencies of the plurality of pressure chambers 46, it is considered to divide the plurality of pressure chambers 46 into a plurality of groups and adjust and input the drive waveform according to the maximum and minimum values of the half cycle AL of the main acoustic vibration frequency of each of the groups. For example, if the maximum value of the half cycle AL of the main acoustic vibration frequency of the plurality of pressure chambers 46 is 3.5 μs and the minimum value is 2.5 μs, the pressure chambers 46 with the AL of 3.5 μs or less to 3.0 μs or more are defined as a first group, and the pressure chambers 46 with the AL of 3.0 μs or less to 2.5 μs or more are defined as a second group. Here, the pressure chamber 46 that satisfies the conditions for both the first and second groups (for example, the pressure chamber 46 with the AL of 3.0 μs) is defined as belonging to either group. For example, if a group of the pressure chambers 46 that satisfies the conditions for both the first group and the second group is made the same as an adjacent group of the pressure chambers 46, management and distinction of each of the groups becomes easier.

Accordingly, maxAL of the first group of the pressure chambers 46 is 3.5 μs and minAL is 3.0 μs. The time interval (time difference) 2*(b−a)*UL between the centers of the ejection waveform of the a-th drop and the ejection waveform of the b-th drop in the n-drop waveforms input to the pressure chambers 46 of the first group is set as (2*(b−a)−0.5)*maxAL<2*(b−a)*UL<(2*(b−a)+0.5)*minAL.

The maxAL of the pressure chambers 46 in the second group is 3.0 μs, and the minAL is 2.5 μs. The time interval (time difference) 2*(b−a)*UL between the centers of the ejection waveform of the a-th drop and the ejection waveform of the b-th drop in the n-drop waveforms input to the pressure chambers 46 of the second group is set as (2*(b−a)−0.5)*maxAL<2*(b−a)*UL<(2*(b−a)+0.5)*minAL.

According to the liquid ejection head 1 in at least one embodiment described above, the waveform widths of the plurality of ejection waveforms in which the plurality of droplets are ejected are set to be substantially the same, and different from the half cycle of the main acoustic vibration frequency. Further, an interval of the plurality of ejection waveforms is set to an interval that coincides with a cycle for strengthening a residual vibration of the liquid in the pressure chamber generated by the ejection waveform generated earlier and a vibration of the liquid in the pressure chamber generated by the ejection waveform generated subsequently. Accordingly, the liquid ejection head 1 can make the ejection forces of the respective droplets substantially the same, that is, approximate or the same, and can increase the ejection speed of the subsequent droplets.

While certain embodiments have been described, these embodiments have been presented by way of example only and are not intended to limit the scope of the disclosure. These novel embodiments can be implemented in various other forms, and various omissions, substitutions, and modifications can be made without departing from the gist of the disclosure. The embodiments and the modifications thereof are included in the scope and the gist of the disclosure, and are included in the scope of the disclosure disclosed in the claims and equivalents thereof.

What is claimed is:

1. A liquid ejection head comprising:
a nozzle plate including a nozzle;
a pressure chamber that is capable of storing liquid and communicates with the nozzle, a volume of the pressure chamber being varied to eject the liquid from the nozzle;
an actuator configured to vary the volume of the pressure chamber in response to a drive signal; and
a drive circuit configured to generate the drive signal, wherein the drive signal includes a plurality of ejection waveforms having waveform widths that are substantially the same and are different from a half cycle of a main acoustic resonance frequency of the liquid in the pressure chamber, and
an interval between centers of two of the ejection waveforms that are adjacent to each other coincides with a period between generation of a residual vibration of the liquid in the pressure chamber by one of the two ejection waveforms and strengthening of the residual vibration by the other of the two ejection waveforms.

2. The liquid ejection head according to claim 1, wherein
the drive circuit includes a switching circuit connected to a plurality of voltage sources corresponding to a plurality of voltages applied by the drive signal.

3. The liquid ejection head according to claim 1, wherein
the interval between the centers of the two ejection waveforms is greater than 1.5 half cycles of the main acoustic resonance frequency and less than 2.5 half cycles of the main acoustic resonance frequency.

4. The liquid ejection head according to claim 1, wherein
an ejection speed of a droplet formed by the other of the two ejection waveforms is greater than an ejection speed of a droplet formed by said one of the two ejection waveforms.

5. The liquid ejection head according to claim 1, wherein
each of the ejection waveforms includes:
an expansion waveform that changes a voltage applied to the actuator from a first voltage value to a second voltage value to expand the volume of the pressure chamber,
an intermediate waveform that follows the expansion waveform and maintains the voltage applied to the actuator at the second voltage value, and
a contraction waveform that changes the voltage applied to the actuator from the second voltage value back to the first voltage value to contract the volume of the pressure chamber.

6. The liquid ejection head according to claim 5, wherein
a length of the intermediate waveform of said one of the two ejection waveforms is greater than or equal to a length of the intermediate waveform of the other of the two ejection waveforms.

7. The liquid ejection head according to claim 1, wherein
a number of changes of voltage values of the voltage applied to the actuator by a leading ejection waveform of the ejection waveforms is greater than a number of changes of voltage values of the voltage applied by a last ejection waveform of the ejection waveforms.

8. The liquid ejection head according to claim 7, wherein
the number of changes of voltage values of the voltage applied by the leading ejection waveform is two.

9. The liquid ejection head according to claim 1, wherein
when one of the plurality of ejection waveforms corresponds to an a-th drop, and another one of the ejection waveforms after the a-th drop corresponds to a b-th drop, a time interval between centers of the ejection waveforms of the a-th and b-th drops is larger than (2*(b−a)−0.5) times a maximum value of the half cycle of the main acoustic vibration frequency, and is smaller than (2*(b−a)+0.5) times a minimum value of the half cycle.

10. The liquid ejection head according to claim 1, wherein
the drive signal forms a liquid droplet having a first ejection volume and ejected at a first speed,
the drive circuit is further configured to generate one or more other drive signals that form a liquid droplet having a second ejection volume and ejected at a second speed, and the first and second speeds are substantially the same.

11. A liquid ejection apparatus comprising:
a plurality of rollers for conveying a print medium; and
a liquid ejection head configured to eject liquid onto the conveyed medium and including:
a nozzle plate including a nozzle,
a pressure chamber that is capable of storing the liquid and communicates with the nozzle, a volume of the pressure chamber being varied to eject the liquid from the nozzle,
an actuator configured to vary the volume of the pressure chamber in response to a drive signal, and
a drive circuit configured to generate the drive signal, wherein
the drive signal includes a plurality of ejection waveforms having waveform widths that are substantially the same and are different from a half cycle of a main acoustic resonance frequency of the liquid in the pressure chamber, and
an interval between centers of two of the ejection waveforms that are adjacent to each other coincides with a period between generation of a residual vibration of the liquid in the pressure chamber by one of the two ejection waveforms and strengthening of the residual vibration by the other of the two ejection waveforms.

12. The liquid ejection apparatus according to claim 11, wherein
the drive circuit includes a switching circuit connected to a plurality of voltage sources corresponding to a plurality of voltages applied by the drive signal.

13. The liquid ejection apparatus according to claim 11, wherein
the interval between the centers of the two ejection waveforms is greater than 1.5 half cycles of the main acoustic resonance frequency and less than 2.5 half cycles of the main acoustic resonance frequency.

14. The liquid ejection apparatus according to claim 11, wherein
an ejection speed of a droplet formed by the other of the two ejection waveforms is greater than an ejection speed of a droplet formed by said one of the two ejection waveforms.

15. The liquid ejection apparatus according to claim 11, wherein
each of the ejection waveforms includes:
an expansion waveform that changes a voltage applied to the actuator from a first voltage value to a second voltage value to expand the volume of the pressure chamber,
an intermediate waveform that follows the expansion waveform and maintains the voltage applied to the actuator at the second voltage value, and
a contraction waveform that changes the voltage applied to the actuator from the second voltage value back to the first voltage value to contract the volume of the pressure chamber.

16. The liquid ejection apparatus according to claim 15, wherein
a length of the intermediate waveform of said one of the two ejection waveforms is greater than or equal to a length of the intermediate waveform of the other of the two ejection waveforms.

17. The liquid ejection apparatus according to claim 11, wherein
a number of changes of voltage values of the voltage applied to the actuator by a leading ejection waveform of the ejection waveforms is greater than a number of changes of voltage values of the voltage applied by a last ejection waveform of the ejection waveforms.

18. The liquid ejection apparatus according to claim 17, wherein
the number of changes of voltage values of the voltage applied by the leading ejection waveform is two.

19. The liquid ejection apparatus according to claim 11, wherein
when one of the plurality of ejection waveforms corresponds to an a-th drop, and another one of the ejection waveforms after the a-th drop corresponds to a b-th drop, a time interval between centers of the ejection waveforms of the a-th and b-th drops is larger than (2*(b−a)−0.5) times a maximum value of the half cycle of the main acoustic vibration frequency, and is smaller than (2*(b−a)+0.5) times a minimum value of the half cycle.

20. The liquid ejection apparatus according to claim 11, wherein
the drive signal forms a liquid droplet having a first ejection volume and ejected at a first speed,
the drive circuit is further configured to generate one or more other drive signals that form a liquid droplet having a second ejection volume and ejected at a second speed, and
the first and second speeds are substantially the same.
